(19) United States
(12) Patent Application Publication
(10) Pub. No.: US 2017/0004590 A1
(43) Pub. Date: Jan. 5, 2017

(54) INVENTORY MANAGEMENT SYSTEM

(71) Applicant: BCD Travel Technology B.V., KS Utrecht (NL)

(72) Inventors: Ilya Gluhovsky, Daly City, CA (US); Alek Vernitsky, Greenbrae, CA (US); Alek Strygin, Foster City, CA (US)

(21) Appl. No.: 15/264,225

(22) Filed: Sep. 13, 2016

Related U.S. Application Data
(63) Continuation of application No. 14/051,211, filed on Oct. 10, 2013.
(60) Provisional application No. 61/712,342, filed on Oct. 11, 2012.

(51) Int. Cl. G06Q 50/14; G06Q 30/02; G06Q 30/06; G06Q 10/02

(52) U.S. Cl. CPC G06Q 50/14; G06Q 10/02; G06Q 30/0204; G06Q 30/0635

(57) ABSTRACT

An inventory management system may be used to facilitate the purchase of a product by a user where the user is associated with a market segment. The system may include an inventory database and a rules database. The product may be a travel product and the purchase terms for the product may reflect a discount, an upgrade or other differentiated attribute.

### CROSS REFERENCE TO RELATED APPLICATIONS

This application is related to and claims priority benefits of U.S. application Ser. No. 14/051,211 (“the '211 application”), entitled “Using Qualification Events to Provide Price Differentiation for Travel Products,” by inventors Ilya Gluhovsky, Alek Vernitsky, and Alek Strygin, filed Oct. 10, 2013. The '211 application is hereby incorporated in its entirety by this reference.

This application is related to and claims priority benefits of U.S. Provisional Application No. 61/712,342 (“the '342 application”), entitled “Method and Apparatus for Price Differentiation Using Pre-Qualification Events,” by inventors Ilya Gluhovsky, Alek Vernitsky, and Alek Strygin, filed Oct. 11, 2012. The '342 application is hereby incorporated in its entirety by this reference.

This application is related to U.S. application Ser. No. 13/656,458 (“the '458 application”), entitled “System and Method for Facilitating the Purchase of a Travel Itinerary Subject to Destination Uncertainty,” by inventors Ilya Gluhovsky, Alek Vernitsky, and Alek Strygin, filed Oct. 19, 2012. The '458 application is hereby incorporated in its entirety by this reference.

This application is related to U.S. application Ser. No. 13/656,466 (“the '466 application”), entitled “System and Method for Facilitating the Purchase of a Travel Itinerary Subject to Date Uncertainty,” by inventors Ilya Gluhovsky, Alek Vernitsky, and Alek Strygin, filed Oct. 19, 2012. The '466 application is hereby incorporated in its entirety by this reference.

This application is related to U.S. application Ser. No. 14/021,598 (“the '598 application”), entitled “Using Upgrade Options to Provide Price Differentiation for Travel Products,” by inventors Ilya Gluhovsky, Alek Vernitsky, and Alek Strygin, filed Sep. 9, 2013. The '598 application is hereby incorporated in its entirety by this reference.

This application is related to U.S. application Ser. No. 14/042,138 (“the '138 application”), entitled “Reducing Selection Uncertainty of Opaque Sales of Travel Products,” by inventors Ilya Gluhovsky, Alek Vernitsky, and Alek Strygin, filed Sep. 30, 2013. The '138 application is hereby incorporated in its entirety by this reference.

### TECHNICAL FIELD

The present disclosure relates generally to providing market segmentation and price differentiation for travel products, and more particularly (although not necessarily exclusively), to techniques for using qualification events and upgrade options to provide price differentiation of travel products, reducing the selection uncertainty of opaque sales of travel products, or completing a booking of a travel package based on a plurality of travel itineraries added to a travel online shopping cart.

### BACKGROUND

Differential pricing, which includes product differentiation and price discrimination, can be a pricing strategy used by businesses for selling products like airline seats, hotel rooms, or other travel products. Differential pricing can be used to sell the right number of products to targeted customers for an appropriate price in order to maximize profit from a fixed, perishable resource. Price discrimination or price differentiation refers to the practice of charging different prices for the same (or very similar) products that have the same costs of production, based solely on different consumers' willingness to pay (“WTP”). Product discrimination, on the other hand, involves charging different prices for products with different quality of service characteristics and, in general, different costs of production. Revenue systems utilize both price discrimination and product differentiation in an attempt to maximize yield. They offer a variety of products, involving differences in the qualities of service, as well as differences in the purchase according to conditions and restrictions.

A related strategy can be market segmentation, which refers to classifying individuals or identifying different demand groups or segments. Market segmentation techniques are used in order to maximize revenues from sale of a fixed, perishable commodity, such as a seat on an airline, a hotel room, cruises, car rental, or any other such products. In theory, total revenue from a product can be maximized when each consumer pays a different price equal to his or her WTP. In practice, such a theoretical segmentation cannot be achieved as the system cannot determine each individual WTP for each particular product, nor can it publish different prices available only to specific individuals.

FIG. 1 illustrates a price demand curve used for price differentiation in airlines. The entire area under the sloping line represents the maximum revenue that an airline may derive from a given flight. If the airline offers an unrestricted fare P1 (price) to those consumers with a higher WTP, the airline can expect Q1 (quantity) consumers to purchase the fare because they have WTP equal to P1 or greater. However, the airline may leave a lot of revenue on the table, both because it did not charge a higher price for those consumers who have WTP>P1, and also because a number of seats are flying empty, as many consumers with WTP<P1 did not buy a ticket.

FIG. 2 illustrates a graphical representation of a typical differential pricing technique of a product. If the airline offers a lower or discount fare P2 to those consumers with a lower WTP, then Q2-Q1 additional consumers would be expected to purchase the lower fare, as they have WTP greater than P2 but less than P1. By introducing two fares, the airline is able to capture a greater portion of the total available revenue. This model assumes that consumers with a high WTP purchase the higher fare P1. Price discrimination presents a challenge of identifying and segmenting customers based on the strength of their preference for a specific product. Without it, profit/yield and market reach of a product are reduced.

For example, consumers prefer high-quality goods over low-quality goods, if prices for all goods are the same. By introducing products of different quality and at different prices, the airlines try to segment the market into consumers with higher and lower WTP. First class, business, premium economy, and economy cabins, as well as tickets that come with expedited security services, priority boarding, and lounge access, are all examples of product differentiation. Furthermore, fare classes and fare basis codes are the most important yield management innovation introduced by the airlines. Fare basis codes are used for selling less desirable flights more cheaply, such as those flying mid-week or off-season, in combination with booking classes, as well as imposing fare rule penalties on refunds or exchanges, thus constituting product differentiation. On the other hand, two prime examples of price discrimination, also often achieved using fare basis codes, are providing corporate discounts and (separately) imposing an advanced purchase restriction. Thus, corporate customers often get a price break on the same product thanks to the volume sales a corporation achieves. Similarly, the same seat being sold far in advance can be cheaper than that sold at the last minute. A problem with the latter strategy can be that it locks out prospective low-WTP customers who were unable or unwilling to commit to travel in advance while precluding an airline from dropping last-minute prices, so that business customers stepping on a plane at the last minute do not catch the same price break and discretionary customers do not develop a habit of buying cheap travel late.

There are other approaches used by airline service providers to sell tickets with offers which yield profits and also optimize the revenue and managing inventory for the airline, thus ensuring to supply consumers with the best products for which they are willing to pay. For example, a prospective purchaser purchasing an airline ticket may commit to purchasing an airline ticket at a reduced price, but the transaction may only occur if the seller makes the ticket available at a designated time near the date of departure. In such scenarios, the utility in a commercial sale of airline tickets can be limited. First, the buyer can be required to make a commitment in advance without any certainty of getting on a flight.

Second, the buyer can be effectively precluded from booking a hotel at his chosen destination because of the uncertainty that the trip will occur, and booking a last-minute hotel may offset any savings from the discounted airfare. Third, on routes with frequent last-minute seat availability, many buyers are likely to adjust their behavior and postpone the full price purchase in favor of an acquisition uncertainty ticket. This creates more empty seats and perpetuates a vicious cycle. Thus, the consumer can be unsure whether the ticket will be booked or not till near the date of departure.

Another approach of revenue management by airlines can be, for example, a Name-Your-Own-Price® (NYOP®) distribution platform that sells opaque fares through buyer-driven pricing. In this NYOP® platform (also referred to as the “Priceline® system”), a customer makes a conditional purchase offer by specifying some characteristics of the itinerary (such as origin, destination, and dates) and the price he is willing to pay. The request can be a commitment by the customer to buy at the offered price. Once the request is made, the Priceline® system searches for an airline that is willing to sell a flight ticket below that price and sends an accept/reject decision back to the customer within a specific time period. If the airline accepts the offer (i.e., a fare exists at or below the buyer-requested price), the flight can be booked and the customer can be charged. Priceline® keeps the margin between the customer-quoted price and the airline price.

Hotwire® offers a platform where, instead of buyer-driven pricing, the price can be disclosed upfront, while the details of the itinerary remain opaque until after the purchase. The opaque sales channels are inferior, both from the airline perspective and from the customer perspective. The opaqueness of the fare downgrades the product by making it less valuable in an attempt to discourage consumption by the high-WTP customers. NYOP® customers must accept considerable uncertainty over the details of their itinerary, including not knowing the airline they will fly, the number of connections, or the exact times of arrival and departure.

In the Priceline® system's implementation, customers are also required to guess the price of an airline ticket and, in an attempt to discourage repeat bidding, wait for a period of time before making another offer. Thus, a buyer may be required to spend a considerable amount of time only to end up with a suboptimal product. In addition, many high-WTP customers exhibit low-WTP behavior. While some business and leisure travelers are likely to be discouraged by the deliberate uncertainty introduced into the transaction (in terms of arrival time, routing, and number of stops), others will perceive the opaque fare as a perfect substitute for the non-opaque fare that allows the buyer to travel from origin to destination and return on the specified dates, resulting in the cannibalization of high-WTP fares, including business fares.

Prepaid airline tickets are made available for purchase in advance of the flights so that the buyer may convert to a specific flight itinerary shortly before the departure, within certain specified parameters (such as a range of dates, a type of seat, etc.), and subject to seat availability. Unlike the unspecified-time ticket, the buyer may not be forced to accept whatever flight and seat the airline offers, and has more flexibility to choose within a range of seats available at the very last minute. For both seller-driven and buyer-driven prepaid tickets, the buyer does not have the certainty of ticket availability until the last minute. Also, the itinerary can be either opaque (some but not all of its attributes are known) or, if not opaque, may present the buyer with a limited selection of last-minute unsatisfactory choices. Hence, there remains a need for market segmentation and consequent price differentiation while balancing the interests of the airline or travel website, where customers are likely to pay close to their individual WTP, with those of a customer, who is least inconvenienced by the price discrimination mechanism.

### BRIEF DESCRIPTION OF THE DRAWINGS

FIG. 1 is a graph illustrating an example of a price demand curve used for price differentiation in airlines according to the prior art.

FIG. 2 is a graph illustrating an example of a differential pricing technique of a product according to the prior art.

FIG. 3 is a block diagram of an example of a system for providing travel products according to one aspect of the present disclosure.

FIG. 4 is a block diagram of an example of qualification events with a set of discount offers according to one aspect of the present disclosure.

FIG. 5 is an illustration of an example of a user interface provided by a presentation apparatus with opaque product options according to one aspect of the present disclosure.

FIG. 6 is an illustration of an example of the user interface of FIG. 5 with identifying details according to one aspect of the present disclosure.

FIG. 7 is an illustration of an example of a user interface provided by a presentation apparatus with an upgrade option according to one aspect of the present disclosure.

FIG. 8 is an illustration of an example of the user interface provided in FIG. 7 with confirmation of the upgrade according to one aspect of the present disclosure.

FIG. 9 is a flowchart illustrating an example of a process of facilitating a purchase of a travel product with qualification events according to one aspect of the present disclosure.

FIG. 10 is a flowchart illustrating an example of a process of facilitating a purchase of a travel product with opaque sales according to one aspect of the present disclosure.

FIG. 11 is a flowchart illustrating an example of a process of facilitating a purchase of a travel product with upgrade options according to one aspect of the present disclosure.

FIG. 12 is a block diagram of an example of a system for providing travel products according to one aspect of the present disclosure.

FIG. 13 is a block diagram of an example of a system including a buyer interacting with a product selection server and a provider through a network to complete a booking based on two or more travel itineraries added to a travel online shopping cart according to one aspect of the present disclosure.

FIG. 14 is a block diagram of the product selection server of FIG. 13 according to one aspect of the present disclosure.

FIG. 15 is an illustration of an example of a user interface view of the product selection server of FIG. 13 displaying two travel itineraries according to one aspect of the present disclosure.

FIG. 16 is an illustration of an example of a user interface view of the product selection server of FIG. 13 for a buyer to enter information for booking one of the two itineraries according to one aspect of the present disclosure.

FIG. 17 is an illustration of an example of a user interface view of the product selection server of FIG. 13 for a buyer to complete a booking or transaction for one of the two destinations according to one aspect of the present disclosure.

FIG. 18 is an illustration of an example of a user interface view of the product selection server of FIG. 13 with a confirmation message that indicates that the at least one travel itinerary and the selected destination has been purchased by the buyer according to one aspect of the present disclosure.

FIG. 19 is a block diagram illustrating an integration of the product selection server of FIG. 13 within a product portal of an airline service provider according to one aspect of the present disclosure.

FIG. 20 is a flow chart of an example of a process for completing a booking for a selected destination on a third-party web page according to one aspect of the present disclosure.

FIG. 21 is a graph of an example revenue-optimal selection probability of a product from the pool of substitutable product options according to one aspect of the present disclosure.

FIG. 22 is a block diagram of a system for providing price differentiation of travel products with date uncertainty or destination uncertainty according to one aspect of the present disclosure.

FIG. 23 is a flow chart of an example of a process for booking a travel product with date uncertainty or destination uncertainty according to one aspect of the present disclosure.

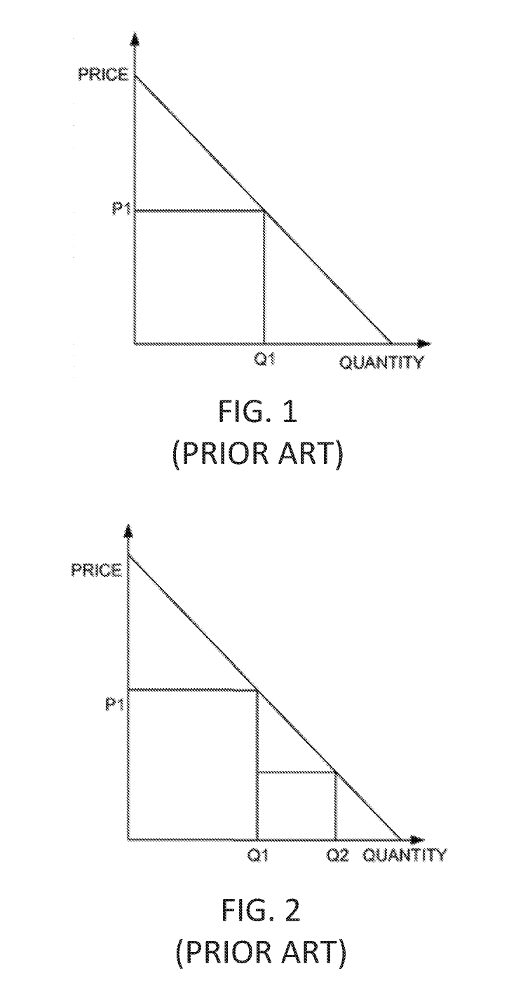

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as not to unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-read able storage medium, which may be any device or medium that can store code or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code or data now known or later developed.

The methods and processes described in the detailed description section can be embodied as code or data, which can be stored in a computer-readable storage medium as described above. When a computer system reads and executes the code or data stored on the computer-read able storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, or other programmable logic devices now known or later developed. When the hardware modules or apparatus are activated, they perform the methods and processes included within them.

### Exemplary Price-Differentiation Framework using Qualification Events

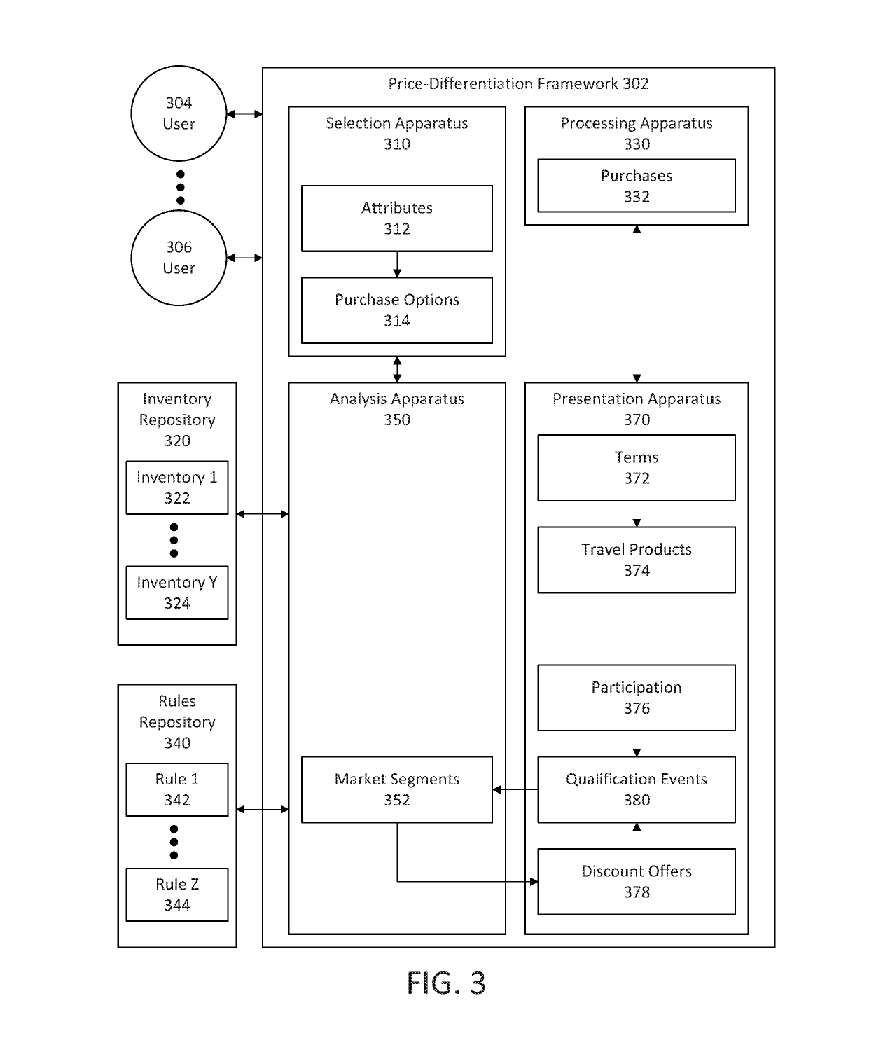

In some aspects, a method and system for facilitating the purchase of travel products such as flights, hotels, rental cars, cruises, tours, or travel packages. As shown in FIG. 3, the system may correspond to a price-differentiation framework 302 that can be accessed by a set of users 304-306, also referred to as “buyers.” Price-differentiation framework 302 includes a presentation apparatus 370, an analysis apparatus 350, and a processing apparatus 330. Each of the components of price-differentiation framework 302 is described below.

In additional or alternative aspects, price-differentiation framework 302 allows users 304-306 to find and purchase travel products. For example, price-differentiation framework 302 may provide a website for browsing, searching, or booking flights, hotels, rental cars, cruises, tours, or travel packages. Price-differentiation framework 302 may also be accessed through a natively installed application on an electronic device such as a mobile phone, tablet computer, portable media player, laptop computer, or personal computer, in lieu of or in addition to the web-based user interface provided by the website.

Moreover, price-differentiation framework 302 may include functionality to perform market segmentation of users 304-306, which in turn may enable price differentiation of travel products offered or sold to users 304-306. To segment users 304-306 into distinct market segments 352, price-differentiation framework 302 may present market-segmentation mechanisms such as hurdles to users 304-306. The hurdles may include restrictions that separate users 304-306 into a first group that can be willing to accept the restrictions in exchange for a lower price and a second group that can be willing to pay a higher price to avoid the restrictions. For example, the hurdles may be associated with opaque purchases, destination uncertainty, or time uncertainty.

During use of price-differentiation framework 302, a user may specify a set of criteria associated with booking travel products 374. For example, the user may specify travel dates, locations, price ranges, star ratings, user ratings, names, reward programs, or features or amenities associated with one or more types of travel products 374 to be purchased through price-differentiation framework 302. Presentation apparatus 370 may match available inventory (e.g., inventory 1 322, inventory y 324) of travel products 374 from an inventory repository 320 to the criteria and provide the matching travel products 374 to the user. For example, presentation apparatus 370 may use one or more application-programming interfaces (“APIs”) to query one or more providers of travel products (e.g., airlines, hotels, rental car companies, cruise companies, tour companies, etc.) or databases for travel products 374 matching the criteria. Presentation apparatus 370 may then list the matching travel products within a website, mobile application, or other mechanism for interacting with the user.

The user may then select a travel product within presentation apparatus 370 for booking, and processing apparatus 330 may process a purchase 332 of the travel product by the user. For example, presentation apparatus 370 or processing apparatus 330 may confirm the details of purchase 332 (e.g., dates, locations, prices, amenities, etc.) with the user, obtain payment (e.g., credit card, debit card, electronic check, online payment) information from the user, and perform purchase 332 by booking the travel product using the payment information.

In addition, price-differentiation framework 302 may include functionality to perform opaque sales of travel products 374 in inventory repository 320. More specifically, presentation apparatus 370 may obtain one or more terms 372 of an opaque purchase (e.g., purchase 332) from the user. For example, presentation apparatus 370 may allow the user to specify a set of travel dates, a star rating, a city, a region within the city, or a price for a hotel booking to be conducted using the opaque purchase. Presentation apparatus 370 may provide one or more travel products matching the terms to the user without disclosing one or more identifying details of the travel product(s). Continuing with the above example, presentation apparatus 370 may initially withhold the names or addresses of hotels that match the user's terms. Instead, presentation apparatus 370 may disclose the name and location of a hotel only after the user has committed to booking the hotel.

In exchange for the opacity, price-differentiation framework 302 may offer travel products at a discount over the regular prices of the travel products. For example, price-differentiation framework 302 may allow a user to book a four-star hotel at a price that may be associated with a three-star hotel. In other words, price-differentiation framework 302 may present a hurdle that constitutes a commitment to purchase a travel product without knowing the identifying details of the travel product. The hurdle may thus segment the market into users who need to know the details of the travel product and are willing to pay the regular price of the travel product and users who are willing to commit to an opaque purchase without knowing the details of the travel product in exchange for a discount. Such segmentation may allow suppliers of travel products to offer lower price points to users in the second category and facilitate the sale of excess inventory while continuing to sell to users in the first category at the normal, higher price point.

On the other hand, users faced with purchase decisions of opaque purchases may face selection uncertainty regarding key attributes (e.g., attributes 312) of the corresponding travel products. For example, an opaque purchase of a flight may withhold the flight's duration and the number of stops, while an opaque purchase of a hotel room may obscure the name of the hotel or detailed amenity information associated with the hotel or hotel room. As a result, the space of potential outcomes can be so broad that a user considering an opaque purchase may incur a large risk factor that can be difficult to assess. For example, the user may assess the risk of committing to an opaque purchase of a hotel room by assembling a comprehensive list of all hotels that may fall under the opaque purchase, then manually researching the details of each hotel in the list. Such risk or overhead may deter the user from using opaque purchase mechanisms to purchase or book travel products through price-differentiation framework 302.

In additional or alternative aspects, price-differentiation framework 302 mitigates such selection uncertainty or risk by providing multiple purchase options 314 associated with an opaque purchase after the user has committed to making the opaque purchase. The opaque purchase may also be associated with a number of purchase options that are provided to the user after the user has committed to making the opaque purchase. By providing a better fit to the user's needs, the purchase options may reduce the user's risk in purchasing an unidentified travel product.

Purchase options 314 may include the travel product initially offered in the opaque purchase, as well as one or more other travel products with attributes 312 that may differ from one or more terms 372 of the opaque purchase. In particular, selection apparatus 310 may select purchase options 314 based on attributes 312 or a set of rules (e.g., rule 1 342, rule z 344) from a rules repository 340. Attributes 312 may include prices, locations, qualities, brands, types, amenities, suppliers, or schedules associated with travel products 374. Attributes 312 may also include an availability of purchase options 314 or the user's preferences.

Rules from rules repository 340 may describe the applicability of travel products as purchase options 314 based on attributes 312 of travel products 374 and terms 372. The rules may thus specify the amount by which the attributes of each purchase option must match or differ from terms 372 or the number of purchase options 314 to be provided. For example, the rules may populate purchase options 314 with higher-priced travel products than the travel product initially offered in the opaque purchase. The rules may also vary the locations, qualities, amenities, suppliers, schedules, or other attributes 312 of purchase options 314 to provide differentiated purchase options 314 to the user. The rules may further allow the user to specify the attributes across which purchase options 314 are varied. The rules may be provided by suppliers of the premium travel products (e.g., hotels, car rental companies, cruise companies, tour companies, airlines, etc.) or price-differentiation framework 302 and aggregated in rules repository 340 for subsequent use by price-differentiation framework 302.

Presentation apparatus 370 may also indicate or obtain additional information associated with purchase options 314 prior to receiving the commitment to make the opaque purchase from the user. For example, presentation apparatus 370 may display the number of purchase options 314 or a differentiating or shared attribute of purchase options 314 within or next to a preview of the opaque purchase that can be shown to the user. Presentation apparatus 370 may also include functionality to obtain a user preference of one or more attributes 312 across which the user would like purchase options 314 to be differentiated, and selection apparatus 310 may apply the user preference during selection of purchase options 314. Moreover, the user preference may be implicit, so that purchase options 314 are customized or personalized to the user. For example, purchase options 314 may be based on the user's search or purchase history with price-differentiation framework 302. Such additional information may mitigate the selection uncertainty or reduce the risk associated with committing to the opaque purchase without revealing key details that may be used to identify the travel products associated with the purchase options.

As mentioned above, purchase options 314 may be provided to the user after a commitment to make the opaque purchase can be received from the user. For example, presentation apparatus 370 may display a list containing the names, addresses, star ratings, prices, or amenities of hotels offered as purchase options 314 for an opaque purchase of a hotel room. If, instead, the opaque purchase can be for a flight, presentation apparatus 370 may display a list containing arrival times, departure times, connection times, numbers of stops, airlines, classes of service, or prices of flights offered as purchase options 314.

Moreover, presentation apparatus 370 may disclose only attributes (e.g., attributes 312) that differentiate purchase options 314 from one another and continue to withhold details that may be used to identify purchase options 314. For example, presentation apparatus 370 may disclose the prices and amenities offered at each of three hotels without providing the names or addresses of the hotels. Along the same lines, presentation apparatus 370 may present three flights by price and respective departure times in the morning, afternoon, and evening without revealing the specific itineraries of the flights or the airlines operating the flights. By withholding identifying details of purchase options 314 during the user's decision to choose among purchase options 314, price-differentiation framework 302 may present another set of opaque purchases to the user.

Presentation apparatus 370 may then obtain a selection of a purchase option from the user, and processing apparatus 330 may process the opaque purchase with the selection. The user may also be required to meet one or more other conditions associated with the purchase option prior to completing the opaque purchase. For example, the user may be required to provide additional information that can be used for market research purposes, refer one or more other users to price-differentiation framework 302, or promote price-differentiation framework 302 or the purchase option on a social network. Fulfillment of such conditions may be confirmed by presentation apparatus 370, processing apparatus 330, or another component of price-differentiation framework.

Consequently, the system of FIG. 3 may preserve the market segmentation associated with opaque sales and allow inventory providers to hide distinguishing product details until a purchase commitment can be received. Such opacity may preclude competition with other sales channels of the inventory providers and preserve the existing customer bases of the inventory providers. At the same time, the system of FIG. 3 may allow the users to choose among multiple purchase options 314, thereby providing a better fit to the needs of the users. Price-differentiation framework 302 may thus increase the value of opaque purchases to both the users and the inventory providers.

Price-differentiation framework 302 may also present a hurdle with destination uncertainty, such as an “alternative destinations” mechanism. The “alternative destinations” mechanism may allow the user to add two or more travel itineraries to different destinations to a shopping cart and commit to purchasing at least one of the selected travel itineraries. Price-differentiation framework 302 may then select one or more of the destinations in the shopping cart and process a purchase (e.g., purchases 332) of a travel itinerary associated with the selected destination(s) for the user before revealing the purchased travel itinerary to the user.

Along the same lines, price-differentiation framework 302 may present a hurdle with time uncertainty. Similar to the hurdle with destination uncertainty, the hurdle with time uncertainty may allow the user to add two or more travel itineraries with different departure or return dates to a shopping cart and commit to purchasing at least one of the selected travel itineraries. Price-differentiation framework 302 may then select one or more of the travel itineraries in the shopping cart and process a purchase (e.g., purchases 332) of the selected travel itinerary for the user before revealing the purchased travel itinerary to the user.

In additional or alternative aspects, price-differentiation framework 302 uses hurdles or other market-segmentation mechanisms as qualification events 380 for discount offers 378 that are subsequently presented to users 304-306. First, presentation apparatus 370 or another component of price-differentiation framework 302 may detect a participation 376 in one or more qualification events 380 by a user. Participation 376 may be related to the user's access to one or more travel products associated with a qualification event. For example, presentation apparatus 370 may detect the user's participation 376 in the qualification event while the user uses price-differentiation framework 302 to browse or search travel products associated with opaque purchases, destination uncertainty, time uncertainty, or other hurdles. Alternatively, participation 376 may correspond to the user's completion of the qualification event. For example, the user's participation 376 in the qualification event may not be established until the user completes a purchase (e.g., purchases 332) that can be associated with a hurdle (e.g., opaque purchase, destination uncertainty, time uncertainty, etc.).

Moreover, price-differentiation framework 302 may include functionality to accept qualification events 380 from a number of sources. As described above, price-differentiation framework 302 may provide hurdles or other market-segmentation mechanisms that are used as qualification events 380, thus enabling the user's participation 376 in the qualification event. On the other hand, price-differentiation framework 302 may verify the user's participation 376 in an eligible qualification event with another travel-booking mechanism. For example, price-differentiation framework 302 may accept a booking confirmation associated with a hurdle from an online travel agency, airline, rental car company, hotel, or other travel supplier as evidence of the user's participation 376 in a qualification event associated with the hurdle. In addition, price-differentiation framework 302 may set a time limit (e.g., 48 hours) within which the booking confirmation can be provided to be eligible as a qualification event.

After the user's participation 376 in the qualification event can be detected, analysis apparatus 350 may associate the user with a market segment (e.g., market segments 352) based on the qualification event. For example, after the user completes an “alternative destinations” purchase or opaque purchase, analysis apparatus 350 may identify the user as a price-conscious, flexible traveler and place the user in the market segment for price-conscious, flexible travelers. On the other hand, the user's lack of participation 376 in any qualification events 380 may indicate that the user can be less flexible or price-conscious and preclude the user's placement in the same market segment.

Analysis apparatus 350 may also include different market segments 352 representing different types of flexibility or levels of price-sensitivity. For example, analysis apparatus 350 may include market segments 352 associated with different numbers or types of qualification events 380, hurdles, or levels of willingness to pay. As discussed in further detail below, the market segment associated with the user may be changed or updated as the user participates in subsequent qualification events 380, which in turn may reveal additional preferences, needs, or desires of the user.

Analysis apparatus 350 may then use the user's market segment to select a discount offer (e.g., discount offers 378) on a travel product for the user, which may or may not be from the same supplier as the supplier associated with the qualification event. For example, analysis apparatus 350 may select a discount offer on a hotel room at a destination after the user completes an “alternative destinations” purchase of a travel itinerary to the destination. Because the “alternative destinations” purchase places the user in a price-sensitive “leisure” market segment, the user may not be interested in booking a full-price hotel room at a premium hotel chain. At the same time, the hotel chain may post rates that target inflexible business travelers, resulting in a significant number of unsold rooms, particularly outside of business-related events (e.g., conferences, sporting events, etc.) or days associated with business travel (e.g., Monday through Wednesday nights). Consequently, the discount offer on the hotel room may allow the premium hotel chain to receive incremental revenue from the user without cannibalizing revenue from business travelers, who do not have the flexibility to participate in “alternative destinations” purchases.

In addition, the discount offer may be based on a set of rules from a rules repository 340 or available inventory of travel products from an inventory repository 320. The rules may describe the applicability of various discount offers 378 to different market segments 352 based on attributes of market segments 352 or qualification events 380 associated with market segments 352. The rules may be used to first identify a set of discount offers that may be used with the market segment. A discount offer associated with available inventory from inventory repository 320 may then be selected from the set.

More specifically, the rules may match certain qualification events 380 or market segments 352 to discount offers for certain types of travel products. For example, the rules may allow discount offers for car rentals or hotels to be provided for qualification events involving purchases of flights. The rules may also specify a period of validity for a discount offer or the amount by which the travel product can be discounted. For example, the rules may limit the discount provided in the discount offer to a fraction of a purchase price or other value associated with the qualification event to mitigate “gaming” that gives a user a chance to receive a significant discount with the discount offer (e.g., a heavily discounted hotel room) after making a cheap purchase in the qualification event (e.g., cheap airfare).

Moreover, the rules may limit the amount of discounted inventory for which the user can be eligible (e.g., after participating in the qualification event) or customize the discount offer to the user's behavior or preferences, as revealed by the user's previous interaction with price-differentiation framework 302 or information provided by the user to price-differentiation framework 302. For example, the rules may select an available hotel room with a particular hotel brand for the discount offer based on the user's previous hotel bookings with the hotel brand. The rules may also determine the amount by which the hotel room can be discounted based on the user's price sensitivity, which may be determined from the prices paid by the user for other hotel rooms or the user's participation in market-segmentation mechanisms (e.g., qualification events 380) associated with discounts.

Finally, the rules may restrict use of the travel product in the discount offer to the users associated with the qualification event to prevent another user from taking advantage of the discount offer without qualifying for the discount offer. For example, the rules may require the listing of one of the passengers in a travel itinerary purchased during a qualification event as a guest during a discounted booking of a non-transferable hotel room following the qualification event, thus preventing the transfer or sale of the discounted booking to another user who did not participate in the qualification event. Similarly, the rules may limit the amount of the travel product that can be purchased based on the number of users associated with the qualification event. For example, a travel itinerary with four passengers that can be booked in a qualification event may be used to generate a discount offer for no more than two double rooms at the destination associated with the travel itinerary.

Once the discount offer can be selected, the discount offer can be provided to the user by presentation apparatus 370. For example, presentation apparatus 370 may provide details of the travel product associated with the discount offer, the original price of the travel product, the discounted price of the travel product in the discount offer, or any restrictions (e.g., non-transferability, period of validity, etc.) on the discount offer. On the other hand, presentation apparatus 370 may obscure one or more details of the travel product if the discount offer can be an opaque purchase or associated with destination or time uncertainty. In other words, the discount offer may also include a hurdle, which may allow the discount offer to be used as a qualification event for subsequent discount offers, as discussed below.

If the user accepts the discount offer, processing apparatus 330 may use the discount offer to process a purchase (e.g., purchases 332) of the travel product. For example, presentation apparatus 370 or processing apparatus 330 may confirm the details of the purchase (e.g., dates, schedule, location, discounted price, number of travelers, etc.) with the user, obtain payment (e.g., credit card, debit card, electronic check, online payment) information from the user, and perform the purchase using the payment information.

As mentioned above, the user's participation 376 in the qualification event may be detected before the qualification event completes (e.g., before the user makes a purchase associated with the qualification event). To increase the attractiveness of completing the qualification event, presentation apparatus 370 may indicate the availability of the discount offer during the user's participation 376 in the qualification event. For example, presentation apparatus 370 may inform the user of the availability of a discounted hotel room following an “alternative destinations” flight purchase while the user browses or searches for travel itineraries to place into the shopping cart for the “alternative destinations” mechanism.

Alternatively, the availability of the discount offer may not be revealed until the qualification event has completed because the decision to provide the discount offer may be based on characteristics of the completed qualification event. Consequently, the discount offer may not be provided to all users who participate in the qualification event, even if the users complete the qualification event.

In additional or alternative aspects, discount offers 378 include an upgrade option on a travel product that can be revealed to the user after the user has committed to purchase the travel product. For example, the user may be notified of the opportunity to upgrade a hotel room at a three-star hotel to a hotel room at an unidentified four-star hotel after the user makes a non-refundable booking of the three-star hotel room. After the user provides payment information and agrees to be charged for the three-star hotel booking, the user may be presented with details of the four-star hotel and the option to upgrade to the four-star hotel.

In additional or alternative aspects, price-differentiation framework 302 uses upgrade options associated with travel products (e.g., travel products 374) to provide price differentiation of the travel products. Each upgrade option may represent a premium version of a travel product shown to the user. For example, the upgrade option may be associated with a premium travel product with a higher price, a higher rating, better reviews, or better amenities than the travel product. Thus, a three-star hotel may be an upgrade option for a two-star hotel, while a four-star hotel may be an upgrade option for both the three-star hotel and the two-star hotel.

In addition, upgrade options for a given travel product may be offered by suppliers other than the supplier of the travel product. For example, an upgrade option for an airline ticket may include an itinerary on a different airline with fewer stops, a better class of service, greater flexibility, or shorter travel time. An upgrade option for a hotel room may be provided by a different hotel with a higher star rating, user rating, better location, or better amenities. An upgrade option for a rental car may be offered by a different car rental company and include a larger or more luxurious car, free gas, or a free loss damage waiver. An upgrade option on a cruise may be offered by a different cruise company and include a better or more expensive room, increased dining options, free drinks, or onboard credit.

As shown in FIG. 3, selection apparatus 310 may select upgrade options based on attributes 312 associated with travel products 374 or a set of rules (e.g., rule 1 342, rule z 344) from a rules repository 340. Attributes 312 may include prices, locations, qualities, brands, types, or amenities associated with travel products 374. Attributes 312 may also include an availability of upgrade options or the user's preferences.

Rules from rules repository 340 may describe the applicability of premium travel products as upgrade options based on attributes 312 of travel products 374. For example, rules for offering a premium travel product as an upgrade option for a travel product may specify a minimum price to be paid for the premium travel product; the number of premium travel products available as upgrade options; or the name brands, qualities (e.g., star ratings), or types of travel products eligible for upgrade to a given premium travel product. The rules may be provided by suppliers of the premium travel products (e.g., hotels, car rental companies, cruise companies, tour companies, airlines, etc.) as well as the service provider and aggregated in rules repository 340 for use by price-differentiation framework 302.

If a travel product is associated with one or more upgrade options, presentation apparatus 370 may indicate the eligibility of the travel product for the upgrade option(s). For example, presentation apparatus 370 may display a symbol, an icon, or text within or next to a description of the travel product as the user browses a list of travel products 374 matching criteria. As a result, the user may be notified of the opportunity to upgrade the travel product to one or more premium travel products without receiving information about the premium travel product(s).

Instead, the user may be presented with details of the upgrade option(s) after the user provides a commitment to purchase 332 the travel product. For example, presentation apparatus 370 may receive the user's commitment to purchase 332 the travel product after the user provides payment information and agrees to be charged for the travel product. Presentation apparatus 370 may then provide an upgrade option of a premium travel product from a different supplier to the user. For example, presentation apparatus 370 may include details such as the name, location, star rating, user rating, or amenities of the premium travel product.

In addition, the upgrade option may be offered for free to the user, or the upgrade option may be associated with a fee for upgrading to the premium travel product. For example, the upgrade option may include a complimentary upgrade to the premium travel product if the price of the travel product meets the minimum price for purchasing the premium travel product, as specified by rules in rules repository 340. Conversely, if the price of the travel product can be too low to qualify for a complimentary upgrade, the upgrade option may be available for the price difference between the price of the travel product and the minimum price for purchasing the premium travel product.

The user may also be required to meet one or more other conditions to qualify for the upgrade to the premium travel product. For example, the user may be required to provide additional information that can be used for market research purposes, refer one or more other users to price-differentiation framework 302, or promote price-differentiation framework 302 or purchase 332 of the premium travel product on a social network.

The user may then complete purchase 332 with either the original travel product or the premium travel product offered in the upgrade option. If the user accepts the upgrade option, processing apparatus 330 may process purchase 332 with the premium travel product. The system may complete the original booking before offering the upgrade option and cancel this booking when the upgrade option is accepted. Alternatively, a system may place the original booking on hold while offering the upgrade option. If a user accepts the option, the system may remove the hold or let it expire on its own. If the user declines the upgrade option, processing apparatus 330 may process purchase 332 with the original travel product. Finally, the user may be required to pay a penalty if the user does not go through with purchase 332 of either the travel product or the premium travel product. For example, the user may be required to forfeit the price of purchase 332 or pay a different amount if the user backs out of purchase 332.

If multiple upgrade options are associated with the travel product, the user may be presented with some or all of the upgrade options. For example, selection apparatus 310 may select a subset of the upgrade options for presentation to the user based on the amount of premium travel product inventory associated with each upgrade option, the similarity between certain attributes of the premium travel products and the travel product (e.g., room type, flight itinerary, tour destinations, cruise itinerary, trip length, etc.), the conditions of the upgrade options (e.g., fees, additional information, referrals, promotions, etc.), the difference in “quality” (e.g., star rating, user reviews, car class, cabin class, etc.) between the travel product and the premium travel products, or the user's preferences or past behavior. Alternatively, presentation apparatus 370 may list all available upgrade options, and the user may select an upgrade option from the list or proceed with purchase 332 of the original travel product. Some of the upgrade conditions may be different among the upgrade options, such as being associated with different additional fees.

Consequently, the system of FIG. 3 may present a hurdle that constitutes a commitment to purchase 332 a travel product and presentation of details of an upgrade option to a premium travel product after the commitment is made. Because the user has committed to purchasing the original travel product without knowing the details of the premium travel product, which may be unacceptable to the user, the hurdle may segment the market into users who are willing to purchase original, non-upgraded travel products and users who are not willing to make such purchases. Such segmentation may allow suppliers of premium travel products to offer lower price points to users in the first category, thus enticing the users to purchase the premium travel products and facilitating the sale of excess premium inventory while continuing to sell to users in the second category at the normal, higher price point. In addition, the use of rules to match upgrade options to travel products may allow suppliers or sellers of the premium travel products to apply optimization strategies that target specific types of users or aggregate demand by offering a single premium travel product as an upgrade for multiple travel products (e.g., hotels with a certain star rating).

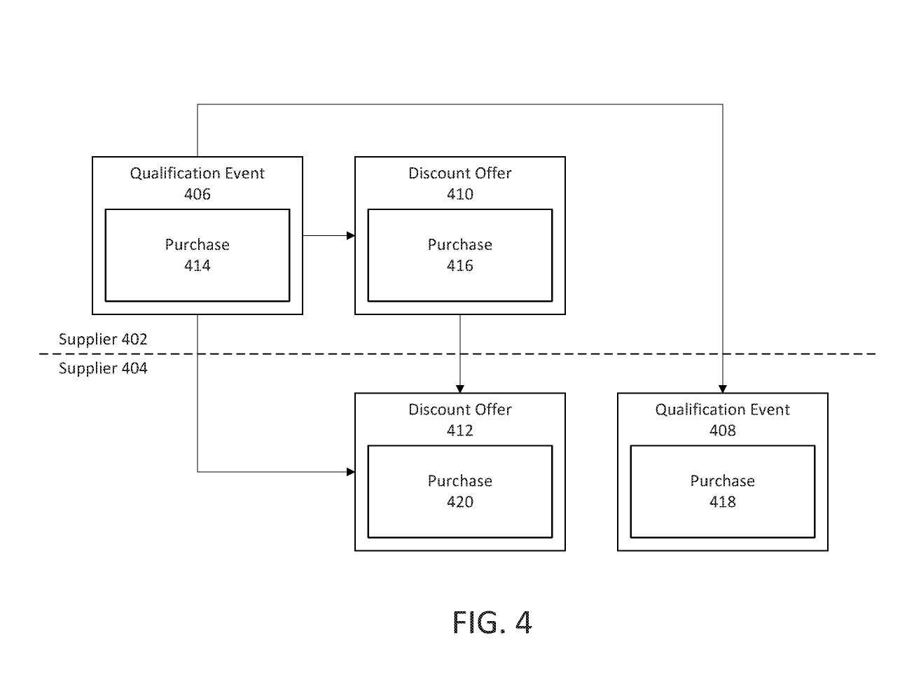

Price-differentiation framework 302 may additionally include functionality to combine multiple qualification events 312 or discount offers 378 for the user. For example, analysis apparatus 350 and presentation apparatus 370 may use rules from rules repository 340 to provide a second discount offer to the user after the user accepts the first discount offer provided after the qualification event, which may also include a discount offer. The second discount offer may use information from the first discount offer or qualification event to further target the user. Analysis apparatus 350 may also associate the user with another market segment after detecting the user's participation 376 in a second qualification event associated with the other market segment. Analysis apparatus 350 and presentation apparatus 370 may then use rules from rules repository 340 to provide an additional discount offer to the user based on the other market segment, in lieu of or in addition to the second discount offer. In other words, price-differentiation framework 302 may use qualification events 380 and previously accepted discount offers to target the user with additional discount offers on travel products, which may also be qualification events. Targeting users using sequences of qualification events and discount offers can be discussed in further detail below with respect to FIG. 4.

Consequently, price-differentiation framework 302 may provide a more robust market-segmentation mechanism than a market-segmentation mechanism that relies on a single qualification event or isolated hurdles such as opaque purchases. The use of restrictions or rules to provide chained qualification events or discount offers may further facilitate effective segmentation of users 304-306. Moreover, such chaining of qualification events 380 or discount offers 378 may produce a purchase flow of travel products, such as air travel followed by a hotel room or a rental car. Offering value-added transactions (e.g., discount offers 378) at various steps of the flow may allow suppliers to increase user participation and satisfaction, which in turn may increase the user' s likelihood of staying with the flow. Finally, market segments 352 or other data associated with participation 376 in qualification events 380 or acceptance of discount offers 378 may be used by independent suppliers to further characterize or target the user.

Moreover, qualification events 380 and discount offers 378 may allow price-differentiation framework 302 to apply market segmentation to tiered transactions that involve more than a single transaction. Examples of conventional tiered transactions may include “Buy 7 Get 1 Free” offers, group discounts at fitness clubs, discounted car washes after gas fills at gas stations, or offering a gift after completing a sale (e.g., at a department store). The conventional tiered transactions may be designed to increase the value of the original purchase to consumers, and may be advertised up front to increase consumer participation. On the other hand, tiered transactions may be performed by price-differentiation framework 302 for the purpose of market segmentation, where special pricing can be made to select users on a personalized basis. Price-differentiation framework 302 may thus treat user touch points as qualifying events and, optionally, as behavioral data generators, while allowing multiple independent (e.g., non-colluding) suppliers to administer these touch points. User- or time-based restrictions may additionally play an important part in ensuring effective segmentation. In other words, discount offers 378 may be viewed as up-selling opportunities targeted at the right market segments.

Those skilled in the art will appreciate that the system of FIG. 3 may be implemented in a variety of ways. First, presentation apparatus 370, analysis apparatus 350, processing apparatus 330, rules repository 340, and inventory repository 320 may be provided by a single physical machine, multiple computer systems, one or more virtual machines, a grid, one or more databases, one or more file systems, or a cloud computing system. In addition, presentation apparatus 370, analysis apparatus 350, or processing apparatus 330 may be implemented together or separately by one or more hardware or software components or layers.

Second, qualification events 380, market segments 352, and discount offers 378 may be used to provide segmentation of users 304-306 in a number of ways. As mentioned above, chaining of qualification events 380 and discount offers 378 may facilitate increased segmentation, price differentiation, or targeting of users 304-306. Similarly, market segments 352 may be redefined as information about users 304-306 can be collected through participation 376 in qualification events 380 or purchases 332 of discount offers 378. Finally, qualification events 380 may not require the use of hurdles or purchases associated with the hurdles. For example, a user's market segment may be established based on the user's filters, settings, or purchases associated with travel products that are not subject to opacity or uncertainty.

Additionally, as mentioned above, inventory and rules associated with travel products and premium travel products may be obtained or aggregated from a number of sources. For example, price-differentiation framework 302 may communicate with one or more booking systems, travel suppliers, or extranets to obtain travel inventory or rules for inclusion in inventory repository 320 or rules repository 340, respectively.

FIG. 4 is a block diagram of an example of qualification events 406-408 with a set of discount offers 410-412 according to some aspects. First, a user may participate in qualification event 406 associated with a first supplier 402 by making a purchase 414 associated with qualification event 406. For example, the user may make purchase 414 after accepting or overcoming a hurdle, such as an opaque purchase with or without purchase options, a destination uncertainty, a time uncertainty, or a purchase commitment with an upgrade option.

In turn, the user may be associated with a market segment, which may qualify the user for discount offer 410. For example, the user's participation in the hurdle from qualification event 406 may place the user in a price-sensitive “leisure” market segment and allow the user to receive discount offer 410 from the same supplier 402 on a travel product that can be normally priced for inflexible or less price-sensitive business travelers. The user may then make a purchase 416 using discount offer 410.

Qualification event 406 and discount offer 410 may also be used by a second supplier 404 to qualify the user for additional discount offers or target the user based on the user's market segment. As shown in FIG. 4, supplier 404 may use information from previous purchases 414-416 for both qualification event 406 and discount offer 410 to generate discount offer 412 for purchase 418 by the user. In particular, supplier 404 may use qualification event 406 to identify the user's market segment and determine that the user is eligible for discount offer 412. Supplier 404 may then use discount offer 410 to generate a related or complementary discount offer 412 with which to target the user. For example, supplier 404 may use an opaque purchase 414 of a hotel room as qualification event 406, which associates the user with a price-conscious, flexible market segment. Next, supplier 404 may use a discounted purchase 416 of a whale-watching tour following the opaque purchase 414 to infer the user's interest in outdoor activities and target the user with discount offer 412 for a different outdoor activity (e.g., bicycle tour, snorkeling tour, parasailing, etc.). Because discount offer 412 is personalized to the user based on purchases 414-416, supplier 404 may stand a greater chance of the user making purchase 418 than if supplier 404 provided a generic or untargeted discount offer to the user.

Similarly, supplier 404 may require the user to participate in an additional qualification event 408 after participating in qualification event 406 to make a purchase 420 associated with qualification event 408. Qualification event 408 may be used to further assess the user's market segment and determine the user's eligibility for purchase 420. Such chaining of qualification events 406-408 may be used to offer deep discounts or prevent cannibalization of other market segments by purchase 420.

For example, qualification event 406 may be an “alternative destinations” mechanism that results in purchase 414 of a travel itinerary to a destination selected by the “alternative destinations” mechanism. In turn, qualification event 408 may include an upgrade option on a non-refundable hotel booking, which can be completed with the non-refundable booking and exercise of the upgrade option. Qualification event 408 alone may cannibalize a full-price booking of the hotel associated with the upgrade option from a business traveler if the business traveler's organization can be willing to exercise the upgrade option in lieu of booking a premium hotel with a known identity. However, such cannibalization may not occur if qualification event 408 can be coupled with qualification event 406 because the business traveler would not have the flexibility to purchase the travel itinerary using the “alternative destinations” mechanism. Conversely, qualification event 408 may deter a leisure traveler who attempts to use the “alternative destinations” mechanism to purchase a flight to a cheap destination with expensive hotels and receive a subsequent, guaranteed discount offer (e.g., discount offers 410-412) on a hotel at the destination. In other words, the combination of qualification events 406-408 may reduce the likelihood of a user in the wrong market segment circumventing both qualification events 406-408.

### Exemplary User Interfaces for a Presentation Apparatus

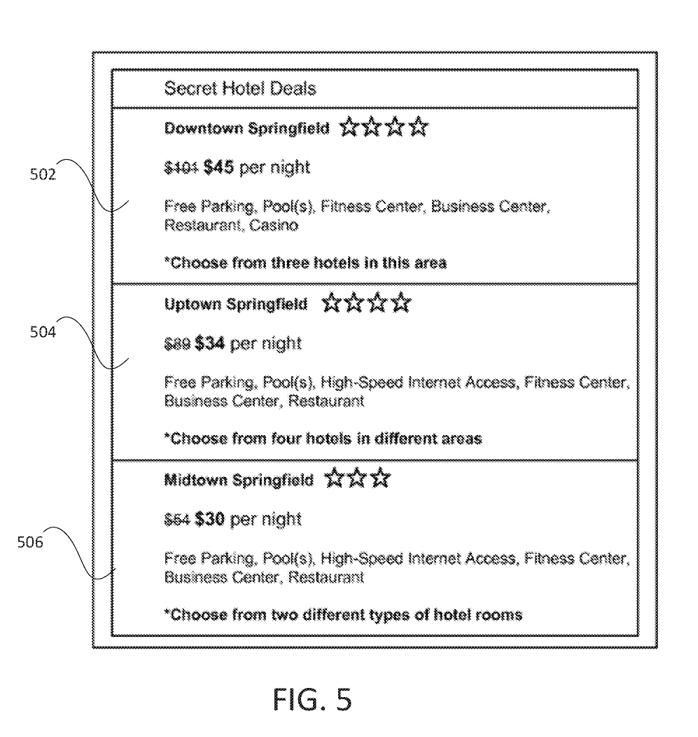

FIG. 5 is an illustration of a user interface provided by a presentation apparatus, such as presentation apparatus 370 of FIG. 3, with opaque product options. As shown in FIG. 5, the user interface includes information 502-506 associated with three possible opaque purchases of travel products such as hotel rooms. For example, information 502 may describe a four-star hotel with a geographic area of “Downtown Springfield,” a discounted rate of $45 per night instead of $101 per night, and amenities that include free parking, swimming pools, a fitness center, a business center, a restaurant, and a casino. Information 504 may describe a four-star hotel with a geographic area of “Uptown Springfield,” a discounted rate of $34 per night instead of $89 per night, and amenities that include free parking, swimming pools, high-speed Internet access, a fitness center, a business center, and a restaurant. Information 506 may describe a three-star hotel with geographic area of “Midtown Springfield,” a discounted rate of $30 per night instead of $54 per night, and amenities that include free parking, swimming pools, high-speed Internet access, a fitness center, a business center, and a restaurant. As a result, information 502-506 may be used to offer three travel products at discounted rates to a user without revealing identifying details of the travel products.

Information 502-506 may also include a description of a set of purchase options for each of the opaque purchases. For example, information 502 may indicate the availability of three purchase options in the same area as that of the corresponding opaque purchase (e.g., “Choose from three hotels in this area”). Information 504 may indicate the availability of four purchase options in different areas from that of the corresponding opaque purchase (e.g., “Choose from four hotels in different areas”). Information 506 may specify the availability of two purchase options representing different types of hotel rooms in the hotel associated with the corresponding opaque purchase (e.g., “Choose from two different types of hotel rooms”). The descriptions of the purchase options may thus provide the number of purchase options available for each opaque purchase, as well as an attribute that can be common to the purchase options (e.g., same geographic area) or differentiates the purchase options from one another (e.g., different geographic areas, different room types).

By indicating the availability and types of purchase options for each of the opaque purchases, the user interface may reduce the selection uncertainty associated with committing to the opaque purchases. In turn, the user may be more likely to commit to one of the opaque purchases than a user who is not offered a set of purchase options prior to committing to an opaque purchase.

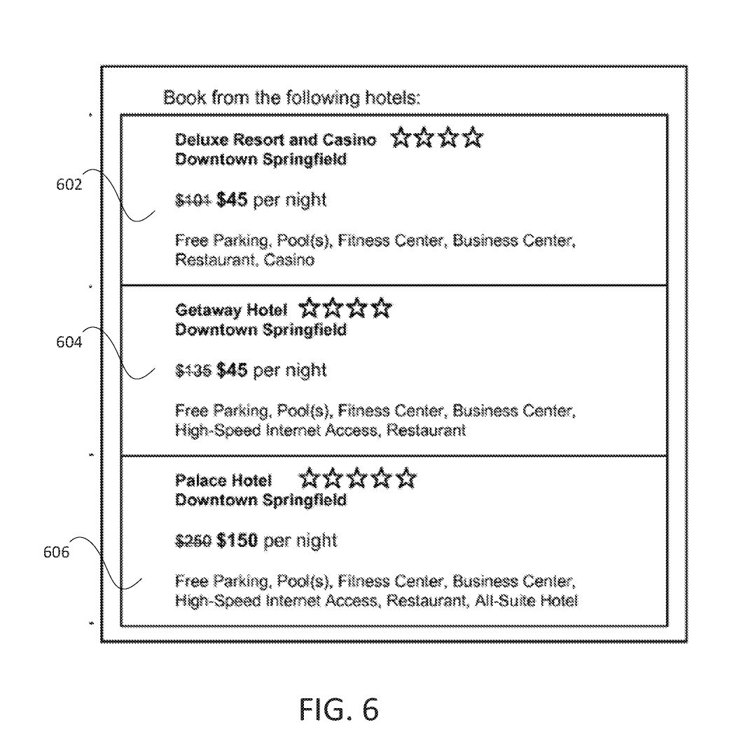

FIG. 6 is an illustration of the user interface of FIG. 5 after the user has committed to making an opaque purchase of the travel product described in information 502. Within the user interface, information 602-606 describing three purchase options is shown.

Like information 502-506 of FIG. 5, information 602-606 describes the travel products corresponding to the purchase options. First, information 502-506, 602-606 indicates that all three purchase options are located in the same geographic area (e.g., “Downtown Springfield”), which fits the description of the purchase options in information 502. In addition, one of the purchase options may conform to the terms of the opaque purchase. For example, information 602 may have the same star rating, discounted rate, and amenities as information 502, thus representing the travel product initially offered in the opaque purchase.

On the other hand, the other purchase options may not be required to conform to terms of the opaque purchase. Instead, one or more attributes may vary across the set of purchase options to differentiate the purchase options from one another. For example, information 604 may specify a four-star hotel with a discounted rate of $45 per night instead of $135 per night and amenities that include free parking, swimming pools, a fitness center, a business center, high-speed Internet access, and a restaurant. Information 606 may describe a five-star hotel with a discounted rate of $150 per night instead of $250 per night and amenities that include free parking, swimming pools, a fitness center, a business center, high-speed Internet access, a restaurant, and an all-suite hotel. Consequently, the purchase options may vary in price, star rating, or amenities to provide variety in the choices available to the user.

As shown in FIG. 6, information 602-606 includes identifying details of the purchase options, such as the names of the purchase options (e.g., “Deluxe Resort and Casino,” “Getaway Hotel,” “Palace Hotel”). Such identifying details may allow the user to further research the purchase options prior to completing the opaque purchase with one of the purchase options (e.g., by selecting the region of the user interface containing the information (e.g., information 602-606) for the purchase option). Alternatively, the identifying details may be withheld until after the user has selected a purchase option with which to complete the opaque purchase. Such withholding of identifying details may provide an additional hurdle that provides additional price differentiation in opaque purchases of travel products.

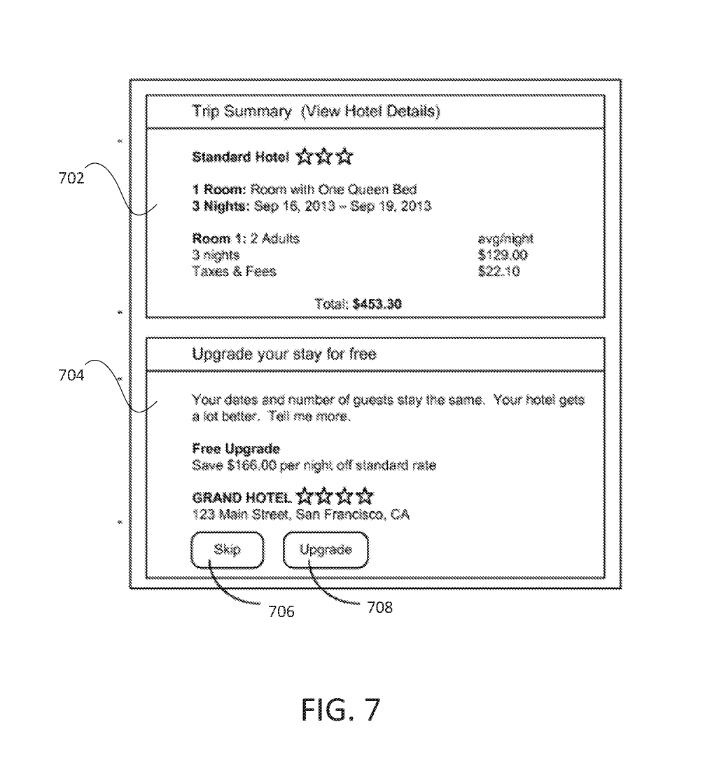

FIG. 7 is an illustration of a user interface provided by a presentation apparatus, such as presentation apparatus 370 of FIG. 3, with an upgrade option. As shown in FIG. 7, the user interface includes information 702 associated with a user's commitment to purchase a travel product such as a hotel room. For example, information 702 may include the name (e.g., “Standard Hotel”) of the travel product, the type (e.g., “1 Room: Room with One Queen Bed”) of the travel product, booking details (e.g., “3 Nights: Sep. 16, 2013-Sep. 19, 2013,” “Room 1: 2 Adults,” “3 nights”) for the travel product, and pricing information (e.g., “Total: $453.30”) for the travel product. Information 702 may be shown to the user before the user has provided payment information and agreed to the terms of the commitment to purchase the travel product and then confirmed upon purchase.

The user interface of FIG. 7 also includes information 704 associated with an upgrade option of a premium travel product. First, information 704 may notify the user of the upgrade option (e.g., “Your dates and number of guests stay the same. Your hotel gets a lot better.”). Next, information 704 may include information about the savings associated with the upgrade option (e.g., “Save $166.00 per night off standard rate”), as well as details about the premium travel product (e.g., “GRAND HOTEL,” “123 Main Street, San Francisco, Calif.”). The user interface may also include links within information 704 to allow the user to access more details of the upgrade option or premium travel product. This information reveals the upgrade option and can be shown in its entirety upon receiving a purchase commitment from the user.

Finally, the user interface of FIG. 7 includes a set of buttons 706-708. The user may select button 706 (e.g., “Skip”) to decline the upgrade option. On the other hand, the user may select button 708 (e.g., “Upgrade”) to accept the upgrade option.

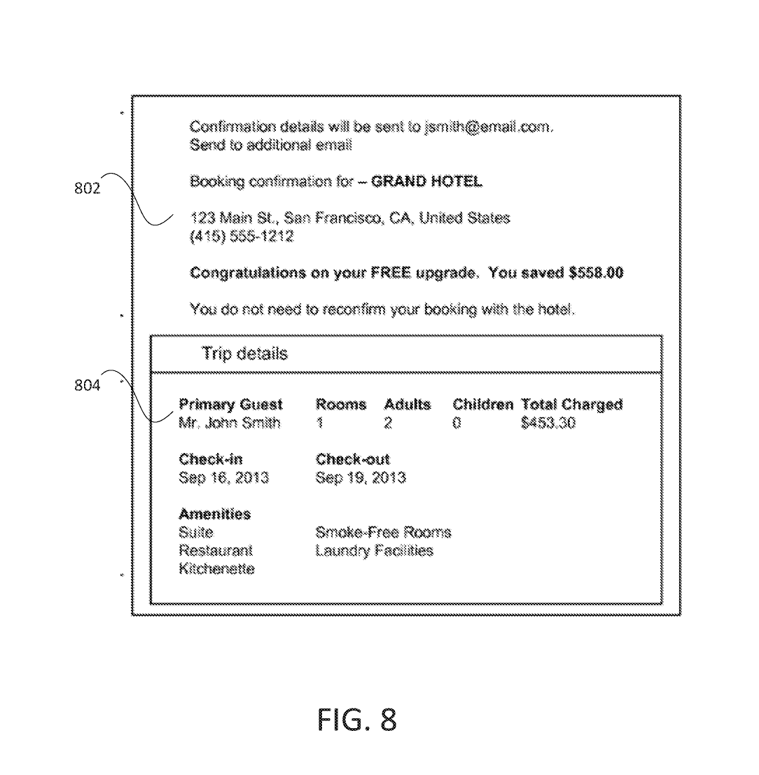

FIG. 8 is an illustration of an example of the user interface of FIG. 7 after the user has selected button 708, thereby accepting the upgrade option. As shown in FIG. 8, the user interface includes information 802 related to the confirmed purchase of the premium travel product. For example, information 802 may include the name (e.g., “GRAND HOTEL”), location (e.g., “123 Main St., San Francisco, Calif., United States”), and phone number (e.g., “(415) 555-1212”) of the premium travel product. Information 802 may also include details about the amount saved (e.g., “Congratulations on your FREE upgrade. You saved $498.00”) by the user in selecting the upgrade option.

The user interface may also include details 804 associated with the purchase. For example, details 804 may specify the name of a guest (e.g., “Mr. John Smith”) using the premium travel product; the number of rooms (e.g., “1”), adults (e.g., “2”), and children (e.g., “0”) associated with use of the premium travel product; the amount paid (e.g., “$453.30”) for the premium travel product; and check-in (e.g., “Sep. 16, 2013”) and check-out (e.g., “Sep. 19, 2013”) dates for the premium travel product. Finally, details 804 may include a set of amenities (e.g., “Suite,” “Smoke-Free Rooms,” “Restaurant,” “Laundry Facilities,” “Kitchenette”) of the premium travel product.

By providing an upgrade option for the travel product, the user interface may allow a supplier of the premium travel product to sell the premium travel product at a price that can be acceptable to the user. At the same time, the occlusion of details of the premium travel product until after the user has committed to purchasing the travel product may segment the user from other users who are not willing to purchase the travel product and would rather pay a higher price for a guaranteed booking of the premium travel product.

### Exemplary Processes for Completing a Booking with a Qualification Event

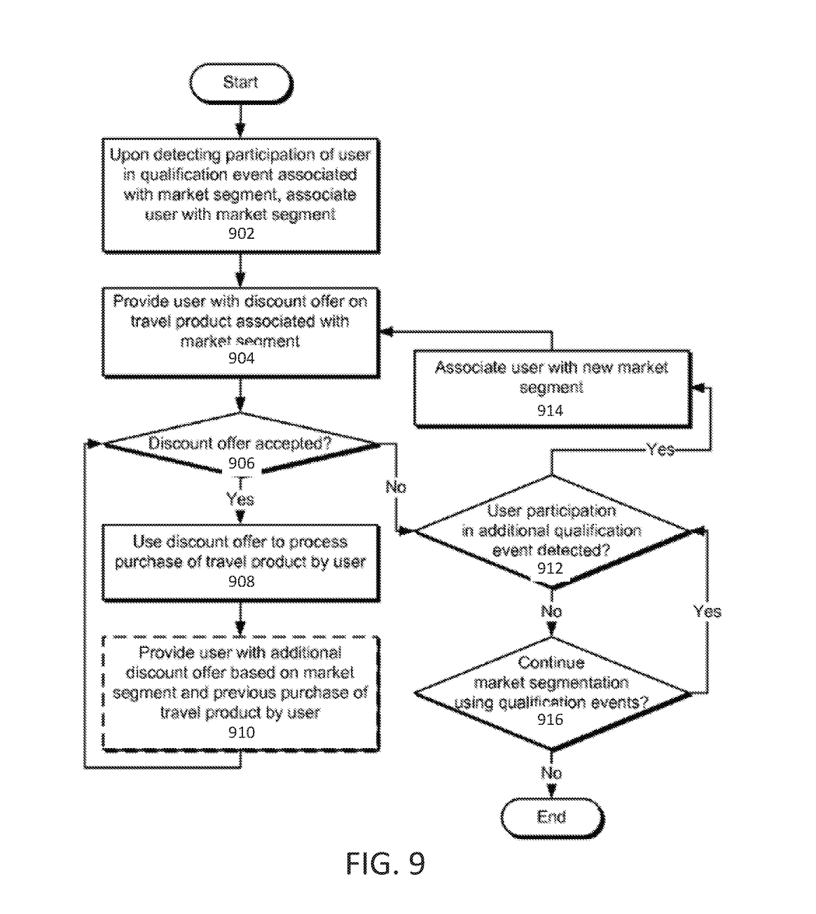

FIG. 9 is a flowchart of an example of a process for facilitating a purchase of a travel product using qualification events. In some aspects, one or more of the steps may be omitted, repeated, or performed in a different order. Accordingly, the specific arrangement of steps shown in FIG. 9 should not be construed as limiting.

Initially, a user can be associated with a market segment upon detecting the user's participation in a qualification event associated with the market segment (operation 902). The qualification event may include a hurdle, an opaque purchase, a set of purchase options for the opaque purchase, an upgrade option, destination uncertainty, or time uncertainty. As a result, the qualification event may segment the user from users who are not willing to jump the hurdle or have a lower tolerance for opacity or uncertainty. In addition, the user's participation in the qualification event may include accessing (e.g., browsing, searching, etc.) one or more travel products associated with the qualification event or the user's completion of the qualification event. Similarly, the user's participation may be detected by enabling the user's participation (e.g., browsing, searching, purchasing, etc.) in the qualification event or verifying the user's participation in the qualification event (e.g., by obtaining evidence of the user's participation from the user).

Next, the user can be provided with a discount offer on a travel product associated with the market segment (operation 904). For example, the user may be offered a discount or an upgrade option on a hotel room at a destination after booking a flight to the destination using an “alternative destinations” mechanism. To mitigate “gaming” of the qualification event or discount offer by the user or other users, the discount offer may be associated with a period of validity, a value associated with the first qualification event, a personalized discount, or use of the travel product by the user or another user associated with the first qualification event. The discount offer may then be accepted by the user (operation 906). If the discount offer is accepted, the discount offer can be used to process the user's purchase of the travel product (operation 908).

In addition, the user may optionally be provided with an additional discount offer based on the market segment and the previous purchase of the travel product by the user (operation 910). For example, the qualification event may qualify the user for the additional discount offer, while the user' s previous purchase of the travel product may be used to tailor the additional discount offer to the user's needs, desires, or preferences. The additional discount offer may be associated with the same supplier as the initial discount offer, or the additional discount offer may be associated with a different supplier.

If the additional discount offer is provided to the user, a purchase using the additional discount offer may be processed based on the user's acceptance of the additional discount offer (operation 906-908). Alternatively, no purchase may be made with the additional discount offer if the user does not accept the additional discount offer. Other discount offers may also be provided (operation 910) and processed (operations 906-908) based on the user's market segment or purchase of other discount offers.

The user's participation in an additional qualification event may also be detected (operation 912). For example, the user may participate in an opaque purchase of a hotel room with purchase options after purchasing a flight using an “alternative destinations” mechanism. Because both purchases are associated with hurdles, the purchases may enable greater segmentation of the user than if each hurdle were used alone. Each qualification event may also include a discount offer or be associated with the same or different suppliers. If the user's participation in the additional qualification event is detected, the user can be associated with a new market segment (operation 914). The user may then be provided with one or more discount offers associated with the new market segment (operations 904-910).

Market segmentation using qualification events may continue (operation 916) during the user's access to or purchase of travel products. If market segmentation is to continue, the user's participation in qualification events (operation 912) can be used to associate the user with different market segments (operation 914), and the user can be provided with discount offers based on the market segments or the user's purchases using other discount offers (operations 904-910). Market segmentation of the user may continue until the user has completed searching, browsing, or purchasing travel products (e.g., during a purchase flow of travel products for upcoming travel).

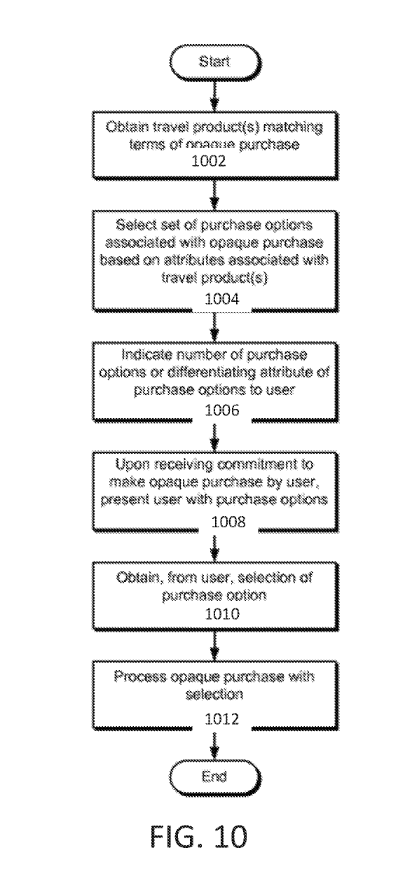

FIG. 10 is a flow chart of an example of a process of facilitating an opaque purchase that obscures one or more details of a travel product. In some aspects, one or more of the steps may be omitted, repeated, or performed in a different order. Accordingly, the specific arrangement of steps shown in FIG. 10 should not be construed as limiting.

Initially, one or more travel products matching the terms of an opaque purchase are obtained (operation 1002). The terms may be provided by a user while browsing or searching for travel products to book or purchase. For example, the user may specify dates, locations, price ranges, star ratings, user ratings, types of travel products, or other criteria for filtering the travel products that may be booked through the opaque purchase.

Next, for each travel product matching the terms, a set of purchase options associated with the opaque purchase can be selected based on attributes associated with the travel product or the user (operation 1004). The attributes may include a price, location, quality, brand, type, amenity, supplier, or schedule associated with the travel product. The attributes may also include the availability of each of the purchase options or a preference of the user. In addition, one or more attributes may be varied across the set of purchase options to differentiate the purchase options from one another. For example, purchase options for flights may vary in price, duration, number of stops, connection points, operating airlines, marketing airlines, departure time, connection time, or arrival time. Similarly, purchase options for hotel rooms may vary in price, star rating, location, amenities, or hotel room types. Such varying of attributes across the purchase options may be provided by a variety-driven technique or set of rules for selecting the purchase options.

The number of purchase options or a differentiating attribute of the purchase options are also indicated to the user (operation 1006). For example, the user may be notified of the number of purchase options or one or more attributes associated with the purchase options (e.g., “includes one or more direct flights for at most $200 extra”) prior to committing to the opaque purchase.

After a commitment to make the opaque purchase by the user is received, the user can be presented with the purchase options (operation 1008). For example, the user may be shown a list of information that uniquely identifies the purchase options or describes the differences in one or more attributes among the set of purchase options. The set of purchase options may include a first purchase option that conforms to the terms of the opaque purchase, as well as one or more additional purchase options that are not required to conform to the terms. For example, the first purchase option may conform to the price of the opaque purchase, while the additional purchase options may be offered at premium prices that are higher than the price of the opaque purchase, or alternatively, discounted prices that are lower than the price of the opaque purchase.

A selection of a purchase option from the available purchase options can be then obtained from the user (operation 1010), and the opaque purchase can be processed with the selection (operation 1012). During processing of the opaque purchase, the user may be required to fulfill one or more conditions to complete the opaque purchase. For example, access to the set of purchase options or selection of specific purchase options in the set may require the user to pay a higher price than initially shown in the opaque purchase, provide additional information, provide a referral, or promote the selected purchase option.

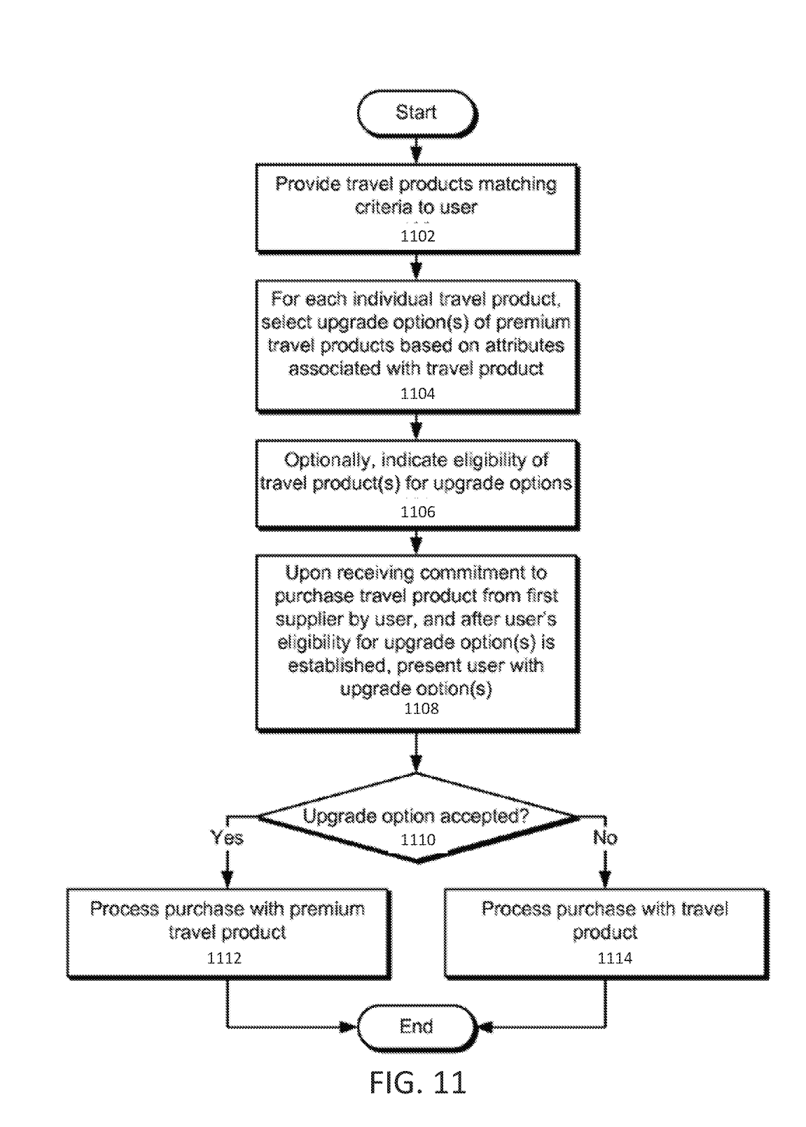

FIG. 11 is a flowchart of an example of a process for facilitating a purchase of a travel product using upgrades. In some aspects, one or more of the steps may be omitted, repeated, or performed in a different order. Accordingly, the specific arrangement of steps shown in FIG. 11 should not be construed as limiting.

Initially, a set of travel products matching a set of criteria can be provided to a user (operation 402). The criteria may be provided by the user while browsing or searching for travel products to book or purchase. For example, the user may specify dates, locations, price ranges, names or name brands, reward or loyalty programs, star ratings, user ratings, types of travel products, or other criteria for filtering the travel products. Available travel products (e.g., flights, hotels, rental cars, cruises, tours, travel packages, etc.) that match the criteria may then be shown to the user within a website, mobile application, or other mechanism for interacting with the user.

Next, individually for each travel product, one or more upgrade options of premium travel products are selected based on attributes associated with the travel product and those of the user profile (operation 1104). The premium travel products may be associated with higher prices, higher ratings, better reviews, or better amenities than the corresponding travel products. The attributes may include a price associated with the commitment to purchase, a location of the travel product, a quality of the travel product, a brand of the travel product, a type of the travel product, an amenity of the travel product, an availability of the upgrade options, or a preference of the user. A set of rules may be applied to the attributes for each travel product to determine if any upgrade options exist for the travel product.

The eligibility of one or more travel products for upgrade options is then optionally indicated (operation 1106) to the user. For example, an icon, symbol, or text indicating the availability of one or more upgrade options may be shown next to or within a description of each eligible travel product. In addition, certain details of the premium travel product could be disclosed. For example, if a travel product is a 3-star hotel, a user can be informed that he would be offered a 4-star hotel as an upgrade option.

Upon receiving a commitment to purchase a travel product from a first supplier by the user, and after the user's eligibility for upgrade option(s) is established, the user can be presented with the upgrade option(s) for the travel product (operation 1108).

For example, the commitment to purchase may be received from the user as payment information and an agreement to be charged for the travel product using the payment information. Upgrade options of premium travel products from other suppliers may then be shown to the user to allow the user to select an upgrade option in lieu of the travel product. In addition, each upgrade option may be associated with a complimentary upgrade to the corresponding premium travel product, or the upgrade option may be subject to one or more conditions. For example, the upgrade option may include a fee for upgrading to the premium travel product, request additional information from the user, require a referral from the user, or require promotion of the premium travel product by the user.

The purchase may then be processed based on the user's acceptance of an upgrade option (operation 1110). If the user accepts the upgrade option, the purchase can be processed with the premium travel product (operation 1112). If the user declines the upgrade option, the purchase can be processed with the original travel product (operation 1114). Finally, if the user does not go through with the commitment to purchase either the travel product or the premium travel product, the user may pay a penalty, such as a cancellation fee.

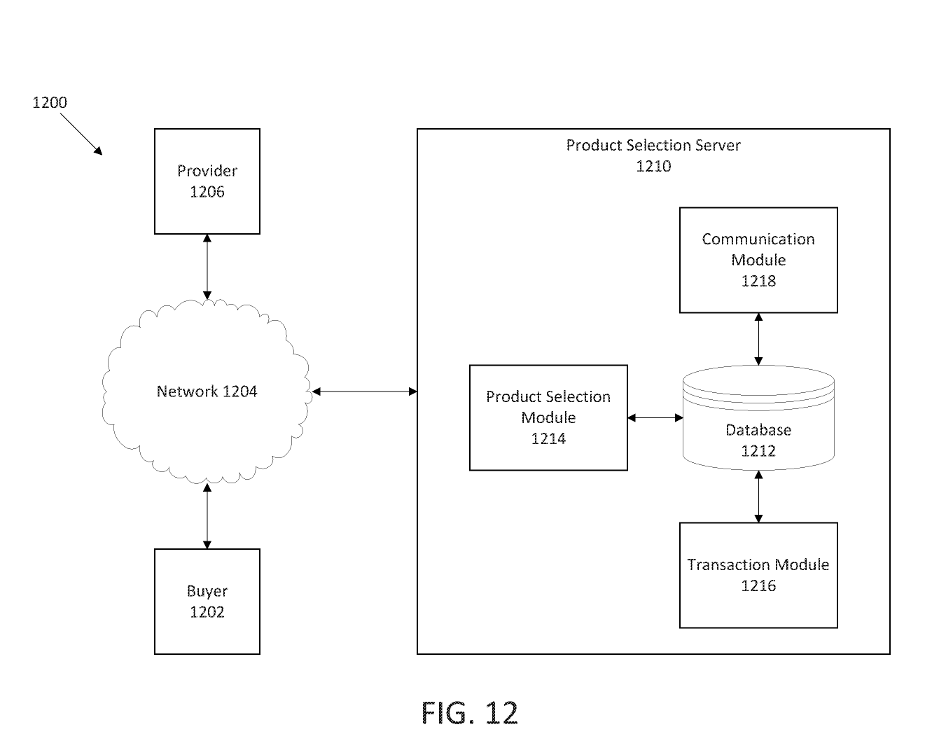

In additional or alternative aspects, market segmentation and price differentiation can be achieved by providing a system and method for completing the purchase of the product from one or more products added to an online shopping cart. FIGS. 12-21 describe additional or alternative aspects for achieving market segmentation and price differentiation. In some systems market segmentation can be achieved by completing the purchase of a product from one or more products added to an online shopping cart.

### Providing Market Segmentation and Price Differentiation Using a Plurality of Travel Itineraries

FIG. 12 is a block diagram of an example of a system including a buyer 1202 interacting with a product selection server 1210 and a provider 1206 through a network 1204 to complete a booking based on two or more travel itineraries added to a travel online shopping cart according to some aspects. The buyer 1202 may create a profile on the product selection server 1210, which can be made accessible to the provider 1206. The buyer 1202 selects two or more travel itineraries to add to the travel online shopping cart. The one or more travel itineraries may include two or more destinations that are diverse enough as a set or sufficiently different from each other based on one or more business rules. The buyer 1202 then provides (i) travel party information and (ii) payer information for the two or more travel itineraries and the two or more destinations. The buyer 1202 agrees (i) to buy a subset of a) the two or more travel itineraries and b) two or more destinations in the travel online shopping cart, and (ii) to a penalty for subsequently canceling the booking. The product selection server 1210 selects at least one destination from the two or more destinations in the travel online shopping cart based on one or more predefined rules specified by the provider 1206. The provider 1206 selects at least one destination from the two or more destinations in the travel online shopping cart based on one or more predefined rules specified by the provider to obtain a selected destination, in one example. The provider 1206 may be an airline service provider, a hotel room service provider, a car rental service provider, or any other travel-related service provider who has a business relationship with the product selection server 1210. Once the selected destination is provided to the buyer, the buyer then selects at least one travel itinerary from the two or more travel itineraries such that the at least one travel itinerary corresponds to the selected destination. The product selection server 1210 then performs a monetary transaction to complete the booking for the at least one travel itinerary and the selected destination. The product selection server 1210 then communicates that the at least one travel itinerary and the selected destination has been purchased by the buyer 1202.

The product selection server 1210 includes a database 1212, a product selection module 1214, a transaction module 1216, and a communication module 1218. The database 1212 stores details of the travel online shopping cart as received from the buyer 1202. The details include two or more travel itineraries, and two or more destinations added by the buyer 1202. Each of the two or more travel itineraries in the travel online shopping cart may have a different destination. Each of the different destinations may serve a different regional market. A subset of the two or more travel itineraries may overlap. An amount of the overlap may be subject to a rule set by the provider 1206. Each of the two or more travel itineraries may have the same travel date, in one example. Each of the two or more travel itineraries may have significantly different spans of dates, in another example. Further, each of the travel itineraries may have the same destination. The travel online shopping cart may include exactly two travel itineraries, in one example. The buyer 1202 may determine a validity of the travel online shopping cart based on the set of business rules. The database may further store details associated with (i) one or more service providers, (ii) one or more buyers, and (iii) one or more non-refundable products. The buyer provides at least (i) travel party information and (ii) payer information for the two or more travel itineraries and two or more destinations.

The product selection server 1210 may dynamically adjust and display a list of travel products (e.g., itineraries and destinations) to the buyer 1202 based on a progressive population or deletion of the two or more travel itineraries from the travel online shopping cart. The list of travel products can be dynamically adjusted based on at least one adjustment criterion. The at least one adjustment criterion may be a distance between destination airports. The list of travel products can be dynamically adjusted based on a set of airlines marketing or operating flights already in the travel online shopping cart as compared to (i) marketing candidate flights or (ii) operating candidate flights, etc.

The product selection server 1210 obtains an agreement from the buyer (i) to buy a subset of a) the two or more travel itineraries and b) the two or more destinations in the travel online shopping cart, and (ii) to a penalty for subsequently canceling the booking. The buyer 1202 may also indicate an affinity (e.g., a relative affinity or an absolute affinity) for each of two or more travel itineraries and two or more destinations in the travel online shopping cart. Upon obtaining the agreement from the buyer 1202, the product selection module 1214 selects at least one destination from the two or more destinations in the travel online shopping cart to obtain a selected destination based on one or more predefined rules specified by the provider 1206.

The provider selects the at least one destination based on (i) a revenue optimization algorithm, (ii) an inventory management algorithm, (iii) an increasing consumer surplus algorithm, or (iv) combinations thereof to solve a multi-objective optimization problem. Once the product selection module 1214 notifies the buyer of the selected destination, the buyer 1202 then selects at least one travel itinerary based on the selected destination. The at least one travel itinerary may be air travel that includes a package that further includes flight details, an air travel ticket, a hotel room, a car rental, or any other travel-related products. The at least one travel itinerary can be selected by the buyer 1202 based on a voucher or a promotional code provided by the provider 1206 when the selected destination can be obtained.

The transaction module 1216 performs a monetary transaction to complete the booking for the at least one travel itinerary and the selected destination. The monetary transaction can be performed based on the affinity indicated by the buyer 1202. The monetary transaction for the selected destination can be (i) not exchangeable, (ii) not refundable, (iii) not transferable, or (iv) not reimbursable, in full or in part. Further, the monetary transaction may be performed to complete the booking for the at least one travel itinerary and the selected destination by (i) obtaining a deposit in part (or in full) from the buyer 1202, or (ii) obtaining a balance upon selection by the buyer 1202 of the at least one itinerary. The balance may be calculated based on an actual itinerary chosen. The communication module 1218 communicates that the at least one travel itinerary and the selected destination has been purchased by the buyer 1202. The travel party may include one or more travelers. Each of the one or more travelers can be booked into the at least one travel itinerary and the selected destination.

The communication module 1218 may further communicate details associated with the at least one travel itinerary and the selected destination. The communication module 1218 may further communicate one or more ancillary services related to the at least one travel itinerary and the selected destination.

The buyer 1202 may select an airline ticket from a first origin to a first destination (e.g., from Chicago to Paris). Further, the buyer 1202 may select another airline ticket from the same first origin to a second destination (e.g., from Chicago to London). During the selection of the tickets, the product selection server 1210 may display a flight selection service, a ticketing service, or a seat map service to the buyer 1202. The buyer 1202 may be provided with an interface to examine and place some itineraries into the shopping cart. Based on the one or more predefined selection algorithms, the product selection server 1210 selects at least one of a destination (e.g., either Paris or London), using the product selection module 1214. For example, where both flights are served by a same airline, by applying the revenue optimization algorithm, the airline may prefer to sell the higher-yielding tickets first to the buyer 1202.

Similarly, if the buyer 1202 indicates he can be indifferent to the choice between a flight from New York to London and a flight from New York to Paris, the provider 1206 may apply that inventory management algorithm to choose and sell a flight from New York to London if it has a greater inventory and seat availability for that flight, and preserve the flight to Paris for sale at a later point. The inventory may be received from a global distribution system (GDS) or a reservation system, or is pre-allocated to the provider 1206.

Similarly, the provider 1206 may apply the customer surplus management algorithm. In such scenarios, the buyer 1202 may be allowed to indicate his greater preference for one product over another product, subject to the restrictions imposed by the service provider. This can be accomplished by the buyer 1202 by using a slider or any another user interface method to indicate his preference for one flight over another (e.g., 65% probability of selecting Paris vs. 35% probability of selecting London). Further, the ability to influence the selection may be used as part of a reward program, where the buyer 1202 can be rewarded with an additional influence on the selection process for engaging in desirable behaviors, such as repeated booking; providing certain information about the buyer 1202 or the trip; linking other travel accounts; logging in with social data, thus allowing the service provider to access user's account information, etc.

Similarly, the supplier management algorithm may be applied when the product selection server 1210 assigns a greater probability of selection to flights provided by certain service providers. The provider 1206 may quote a special price for (i) the two or more itineraries or (ii) two or more destinations. This fare can be lower than the open market fare for the corresponding itinerary for the two or more itineraries, in one example. The fare for the at least one travel itinerary and the selected destination may be lower than an open market fare that corresponds to the at least one travel itinerary and the selected destination.

In some aspects, the system may assign all airports to a particular metropolitan area. To prevent arbitrage, the system may also prevent the buyer 1202 from selecting an airline ticket from a first origin to a first destination airport (e.g., JFK International Airport) and another airline ticket from the same first origin to a second destination airport that serves the same metropolitan area as the first destination airport (e.g., LaGuardia Airport). To assign airports to metropolitan areas, the system may first construct a list of all airports sorted by popularity in descending order where the system bases popularity on origin and destination flight volume data. The system then iterates through the list, starting with the most popular airport. For each airport A1 in the list, the system calculates the distance from A1 to all previously visited airports in the list one by one. If no previously visited airports are within R miles of A1, the system creates a new metropolitan area centered on A1. Otherwise, if the system discovers an airport A2 that is within R miles of A1, the system adds A1 to the metropolitan area that is centered on A2. By iterating through the entire list, the system generates a number of metropolitan areas, each of which contains at least one airport.

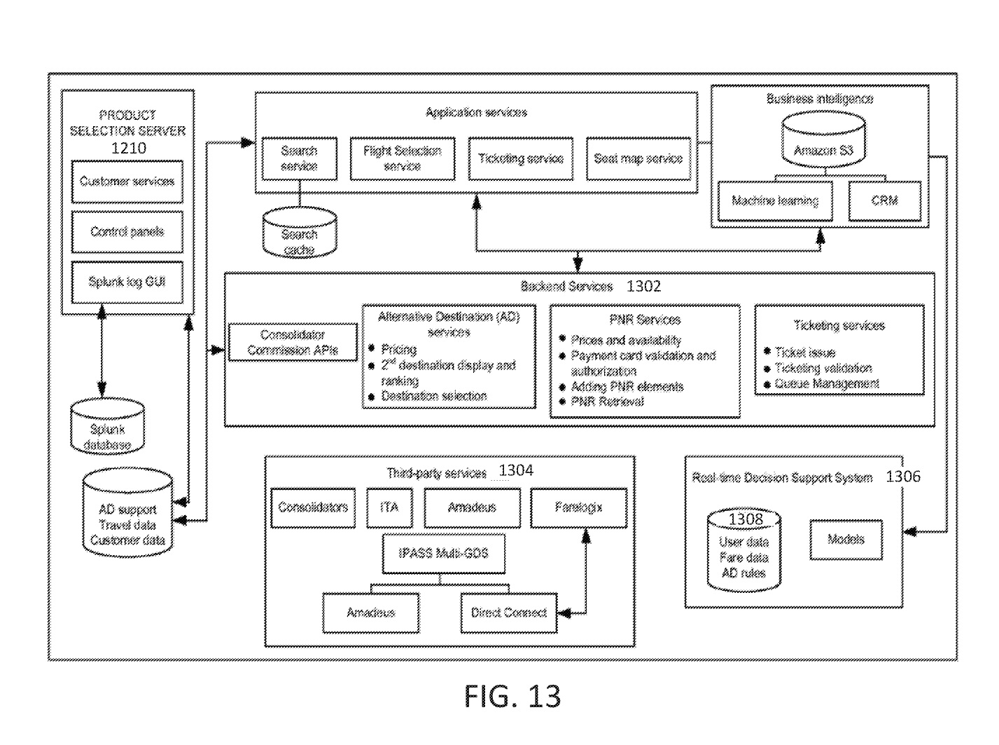

FIG. 13 is a block diagram illustrating an integration of the product selection server 1210 of FIG. 12 within a product portal of an airline service provider according to some aspects. The block diagram of the product portal associated with the airline service provider includes the product selection server 1210, a backend services block 1302, a third-party service block 1304, and a real-time decision support system 1306. The block diagram may further include a business intelligence block that includes a database (e.g., Amazon simple storage service (Amazon S3)), a machine learning block, and a customer relationship management (CRM) block.

The product selection server 1210 includes customer services, control panels, and a Splunk log graphical user interface (GUI) that includes a Splunk database. The backend services block 1302 may include consolidator commission application programming interfaces (APIs), alternative destinations services, passenger name record (PNR) services, and ticketing services. The alternative destinations services block includes details associated with pricing, 2nd destination display and ranking, and destination selection for one or more products (e.g., a travel-related product).

The PNR services may include details such as prices and availability of the one or more products, payment card validation and authorization services, adding PNR elements (e.g., passenger name, address, etc.), and PNR retrieval for further processing. The ticketing services may include ticket issue, ticketing validation, and queue management. The database 1212 may include alternative destinations support services, travel data, and customer data associated with the one or more products. The third-party services block 1304 may include details of one or more third-party service providers (e.g., consolidators, schedule and availability search vendors, GDS, direct connect vendors, etc.) who provide other travel-related products. The database 1212 of the product selection server 1210 may also include alternative destination support service, travel data, and customer data. The real-time decision support system 1306 includes a database 1308.

The database 1308 stores information associated with (i) one or more users, (ii) fare data or pricing of the one or more products, and (iii) alternative destinations rules, etc. The real-time decision support system 1306 provides real-time decision support to the one or more service providers for making one or more decisions for alternative destinations selection. The decisions may be based on the information associated with (i) one or more users (e.g., user data), (ii) pricing of the one or more products (e.g., fare data), and (iii) alternative destinations (AD) rules, etc.

As described above, based on the one or more predefined selection algorithms, a third-party service provider (e.g., the airline service provider) may select at least one of a destination (e.g., either Paris or London) using the product selection module 1214. For example, where both flights in the selected non-refundable travel-related products are served by a same airline and further by applying the revenue optimization algorithm, the airline may prefer to sell the higher-yielding tickets first to the buyer 1202.

Similarly, if the buyer 1202 indicates he is indifferent to the choice between a flight from New York to London and a flight from New York to Paris, the airline service provider may apply that inventory management algorithm to choose and sell a flight from New York to London if it has a greater inventory and seat availability for that flight, and preserve the flight to Paris for sale at a later point.

Similarly, the third-party service provider may apply the customer surplus management algorithm. In such scenarios, the buyer 1202 may be allowed to indicate his greater preference for one product over another product, subject to the restrictions imposed by the service provider. This can be accomplished by the buyer 1202 by using a slider or any another user interface method to indicate his preference for one flight over another (e.g., 65% probability of selecting Paris vs. 35% probability of selecting London). Further, the ability to influence the selection may be used as part of a reward program, where the buyer 1202 is rewarded with an additional influence on the selection process for engaging in desirable behaviors, such as repeated booking; providing certain information about the buyer 1202 or the trip; linking other travel accounts; logging in with social data, thus allowing the service provider to access the user's account information, etc.

Similarly, the supplier management algorithm may be applied when the product selection server 1210 assigns a greater probability of selection to flights provided by certain service providers. The service provider may quote a special price for one or more itineraries. This fare can be lower than the fare for the corresponding itinerary being sold on an open market.

Once the products are selected by the product selection module 1214 based on the one or more predefined algorithms, and an approval from the buyer 1202 to execute, the transaction module 1216 performs the transaction for the selected destination by obtaining required transaction details from the buyer 1202. The buyer 1202 is then charged for the selected product. The airline service provider may apply the same predefined selection algorithms to select one of the two destinations, in one example. The airline service provider may create a different set of selection algorithms (or alternative destinations rules) to select one of the two destinations, in another example herein. The different set of selection algorithms may be created based on inventory, pricing, availability, ranking, or any other such criterion. The airline service provider may then notify the buyer 1202 which product is selected. The selection of at least one of the products may differ when the product selection server 1210 is integrated within a product portal of the airline service provider. For example, the selection of at least one product as performed by the product selection server 1210 when hosted by another service provider may not be similar when hosted by the airline service provider.

### Exemplary User Interfaces for a Product Selection Server

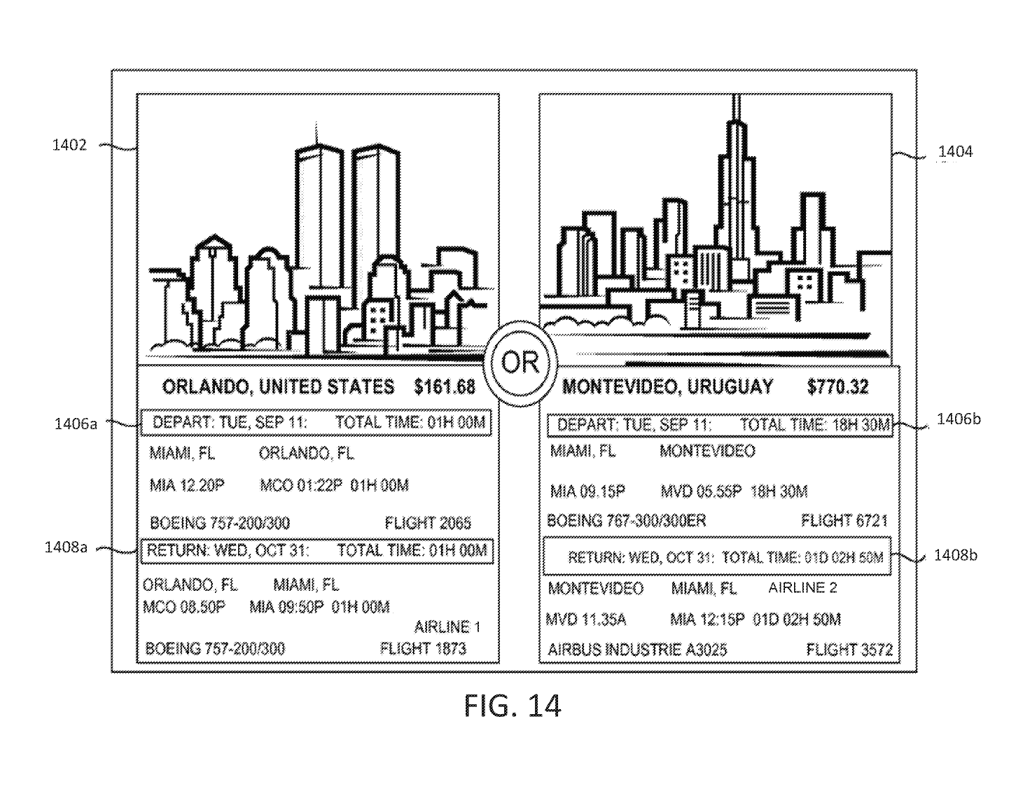

FIG. 14 is an illustration of an example of a user interface view of the product selection server 1210 of FIG. 12 illustrating a comparison of two travel itineraries according to some aspects. The comparison of the two travel itineraries indicates two different destinations 1402 and 1404, in one example. One or more rules may be displayed to the buyer 1202. The rules are provided to the buyer 1202 to ensure the validity of the selected shopping cart. The buyer 1202 commits to purchase (by agreeing to operational and legal guidelines) at least one of the two destinations. The buyer 1202 selects the two different destinations 1402 and 1404 where he can be willing to travel. The first destination is Orlando, Fla., United States, in one example. The second destination is Montevideo, Uruguay, in another example. The first destination 1402 includes a departure field 1406a that indicates departure time and duration of the trip, and a return field 1408a that includes the same information for the return trip of the buyer 1202. The travel itinerary for the first destination may further include flight selected fields that indicate which airline and flight the buyer 1202 has chosen (e.g., Airline 1, departure flight no. 2065 and return flight no. 1873). Similarly, the second destination 1404 includes a departure field 1406b that indicates departure time and duration of the trip, and a return field 1408b that includes the same information for the return trip of the buyer 1202 from the second destination. The travel itinerary for the second destination may further include flight selected fields that indicate which airline and flight the buyer 1202 has chosen (e.g., Airline 2, departure flight no. 6721 and return flight no. 3572). A subset of two or more travel itineraries as shown in FIG. 14 may include air travel details that are opaque. A portion of the itinerary details of the subset are hidden for a substantial period of time when displayed to the buyer 1202. The air travel details may include (i) operating or marketing carrier details, or (ii) departure dates, etc.

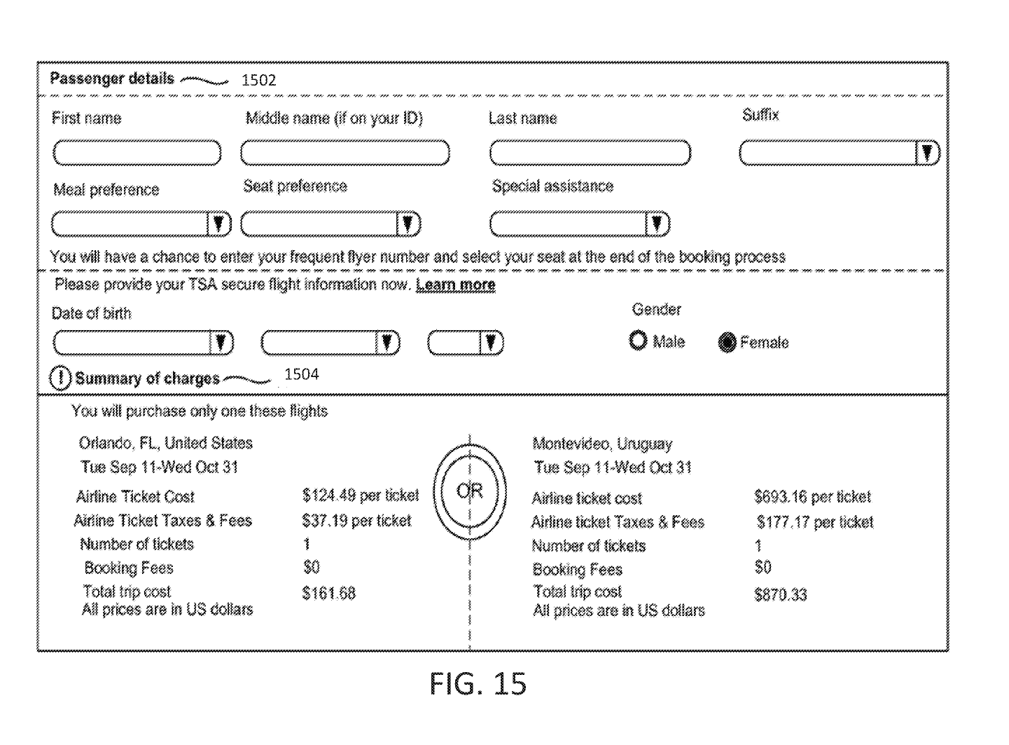

FIG. 15 is an illustration of an example of a user interface view of the product selection server 1210 of FIG. 12 illustrating a method of processing, from the buyer 1202, travel party information and payer information for the two or more travel itineraries and the two or more destinations to perform a monetary transaction to complete the booking for at least one travel itinerary and the selected destination according to some aspects. The user interface view includes a passenger details field 1502 and a summary of charges field 1504. The passenger details field 1502 allows the buyer 1202 to enter his personal information, such as first name, middle name, last name, suffix, meal preference, seat preference, special assistance requirements, date of birth, or gender, etc. The summary of charges field 1504 displays an airline ticket cost, number of tickets purchased, and a total trip cost, etc. for each of the two destinations. Of the two flights, the buyer 1202 will purchase only one.

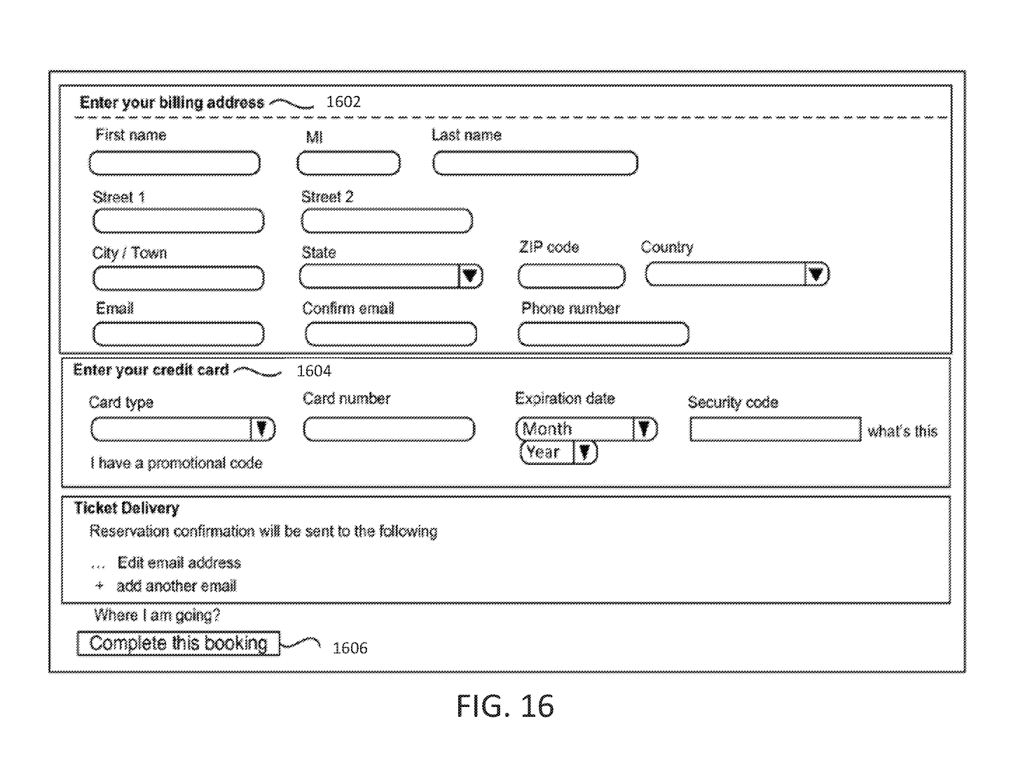

FIG. 16 is an illustration of an example of a user interface view of the product selection server 1210 of FIG. 12 illustrating a method of completing a booking or transaction for one of the two destinations according to some aspects. One of the two destinations can be the selected destination. The user interface view includes an “enter your billing address” field 1602, an “enter your credit card” field 1604, and a “complete this booking” button 1606. The “enter your billing address” field 1602 allows the buyer 1202 to enter his billing address (e.g., first name, middle initial, last name, street, city/town, ZIP code, country, email, phone number, etc.) The “enter your credit card” field 1604 allows the buyer 1202 to enter credit card information (e.g., card type, card number, expiration date, and security code) for completing the transaction. The product selection server 1210 may also enable the buyer 1202 to make payments toward completing the transaction by using any of the payment methods. The buyer 1202 completes the transaction by clicking on the “complete this booking” button 1606. The payment process or the selection process of the products may be hosted on a third-party server, and the buyer 1202 may be redirected to the third-party server to complete the transaction.

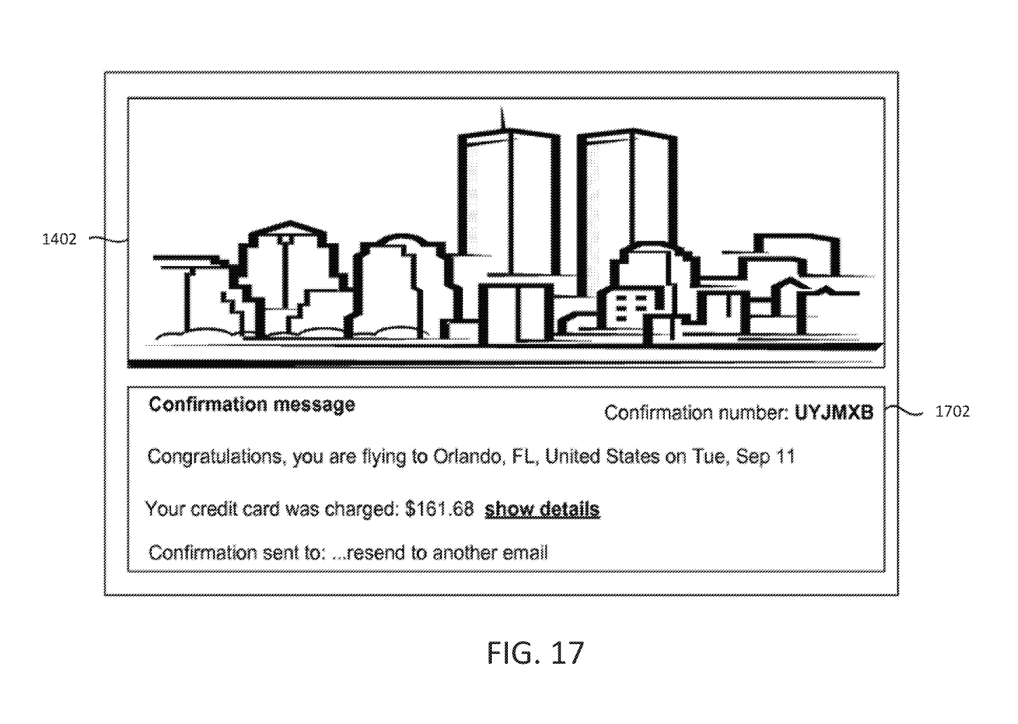

FIG. 17 is an illustration of an example of a user interface view of the product selection server 1210 of FIG. 12 illustrating a method of sending a confirmation message that indicates that the at least one travel itinerary and the selected destination has been purchased by the buyer 1202 according to some aspects. Upon receiving a click on the “complete this booking” button 1606, the product selection module 1214 selects one of the two destinations based on the one or more predefined selection algorithms to obtain the selected destination. The product selection server 1210 selects Orlando, Fla., United States as the place of travel and displays a confirmation message in a confirmation field 1702. The confirmation message may include a confirmation number (e.g., UYJMXB) and destination details (e.g., Congratulations, you are flying to Orlando, Fla., United States, on Tue, September 11, your credit card was charged: $161.68, confirmation sent to: to another email). The buyer 1202 may click on the “show details” link to view additional details related to this transaction. Details of the at least one travel itinerary and the selected destination may be displayed to the buyer 1202 only after performing the monetary transaction.

### Exemplary Processes for Completing a Booking with a Plurality of Itineraries

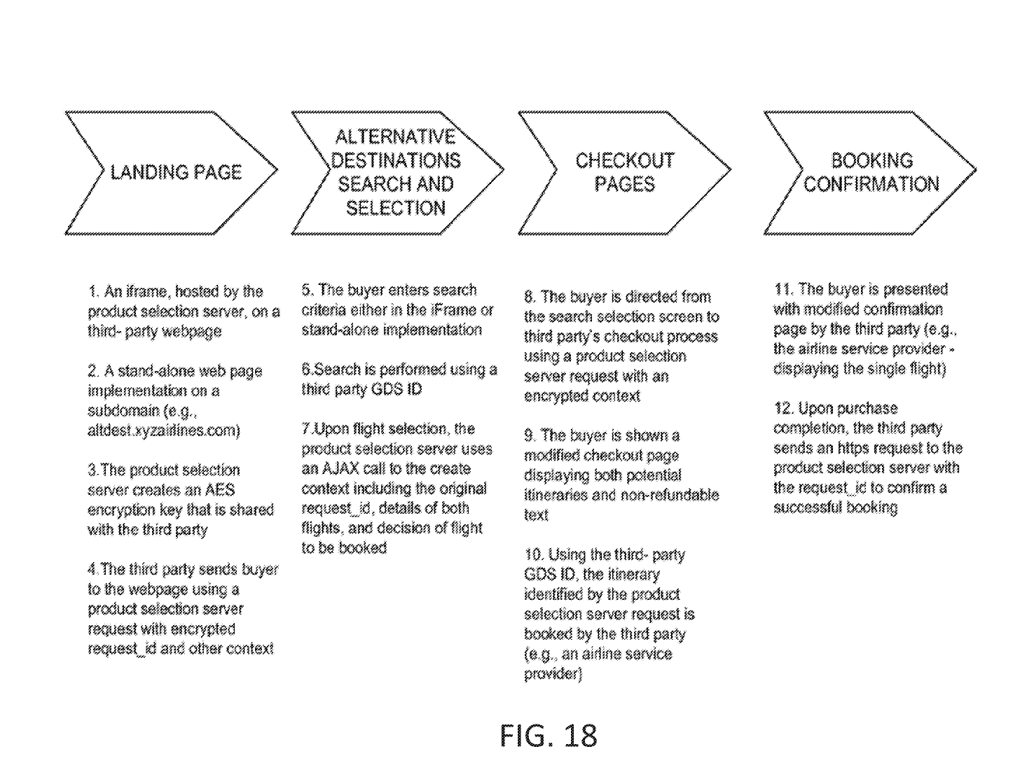

FIG. 18 is a flow chart of an example of a process for completing a booking for a selected destination on a third-party web page according to some aspects. A booking page (e.g., a landing page or an iframe) is hosted by the product selection server 1210 on a web page associated with a third party (e.g., an airline web page, or a third-party web page). The third-party web page is a page on an airline website, in one example. The booking page may include standard header, footer, and navigational menus, in one example. The product selection server 1210 creates HMAC and encryption keys that the airline server and the product selection server 1210 share. The airline creates a link(s) pointing to the Alternative Destinations landing page. For a stand-alone implementation (as opposed to within an iframe) the airline creates (i) a subdomain, such as altdest.xyzairline.com, and (ii) a Global Distribution System (GDS) office id for Alternative Destinations. In one example, the subdomain is altdest.airline.com. The airline loads fares for this office id or provides “paper contract” fares to be loaded into the GDS using a fare loading module, such as GDS fare loading software. This enables the product selection server 1210 to use the existing code base, which further allows the airline to book a flight using the same office id as the one used for searching. The airline creates the checkout flow for Alternative Destinations Customers.

The product selection server 1210 creates an authenticating application key for the airline to send tracking info back to the product selection server 1210. The third party (e.g., the airline) sends the buyer 1202 to the web page using a request (e.g., a product selection server request) with an encrypted request_id and other context.

When the buyer 1202 enters search criteria on the product portal of the airline service provider (e.g., the third party), the search is performed by the product portal of the airline service provider using the GDS office ID. For example, when the buyer 1202 clicks on an Alternative Destinations link on the airline page, a server associated with the airline generates the request_id and sends the buyer to the landing page using a request (e.g., a product selection server request) with an encrypted context (e.g., request_id, together with any additional user context that the airline enables the product selection server 1210 to use, such as the user's first name, for example, {‘request_id’: 17, ‘user_context’: {‘first_name’: ‘Joel’}}, and the HMAC code of the encrypted payload).

During the search, the buyer 1202 may be presented with one or more application services such as a flight selection service, ticketing service, or a seat map service, etc. Upon selection of one or more products (e.g., selecting 2 flights) by the user, the product selection server 1210 uses a call function (e.g., an AJAX call) to create a context including an original request ID, details of the flights associated with the one or more products), and decision of the flight to be booked. For example, upon clicking “Next” of the search result page, the page makes an AJAX call to the product selection server 1210 to generate the context of the buyer request that may include request_id, flight1_details, and flight2_details for the flight that the buyer will get (1 or 2).

The buyer 1202 is then redirected from the selection process page to a checkout page by the product selection server 1210 using the original request ID with the encrypted context. For example, $.ajax ({url: ‘/put_user_context_together’, type: ‘POST’, data: {flight1_details:$.toJSON(flight1.get(‘info’), flight2_details:$.toJSON (flight2.get(‘info’)),}, success:function(response){window.location.href=‘www.xyzairline.com/altdest_checkout?cont ext=’+response.context}}). The buyer 1202 completes the process using the airline's AD checkout flow. The buyer is shown both flights (retrieved from the passed context), the legal text asking the user to agree to either itinerary option, etc. A modified checkout page may be displayed to the buyer 1202 that includes potential itineraries and ticket rule information (such as the ticket being non-refundable, non-exchangeable, etc.). The product portal of the airline service provider then books an appropriate flight based on an itinerary identified by the original request ID, and a global distribution system ID associated with the airline service provider (e.g., Airline). The airline service provider then displays a confirmation page that indicates purchase (completing a monetary transaction) of one flight out of the two flights by the buyer 1202. Upon completing the purchase, the airline service provider (e.g., Airline) transmits an https request to the product selection server 1210 with the request_id and an authenticating key to confirm a successful booking of the flight (e.g., an airline ticket). This allows the product selection server 1210 to track the booking.

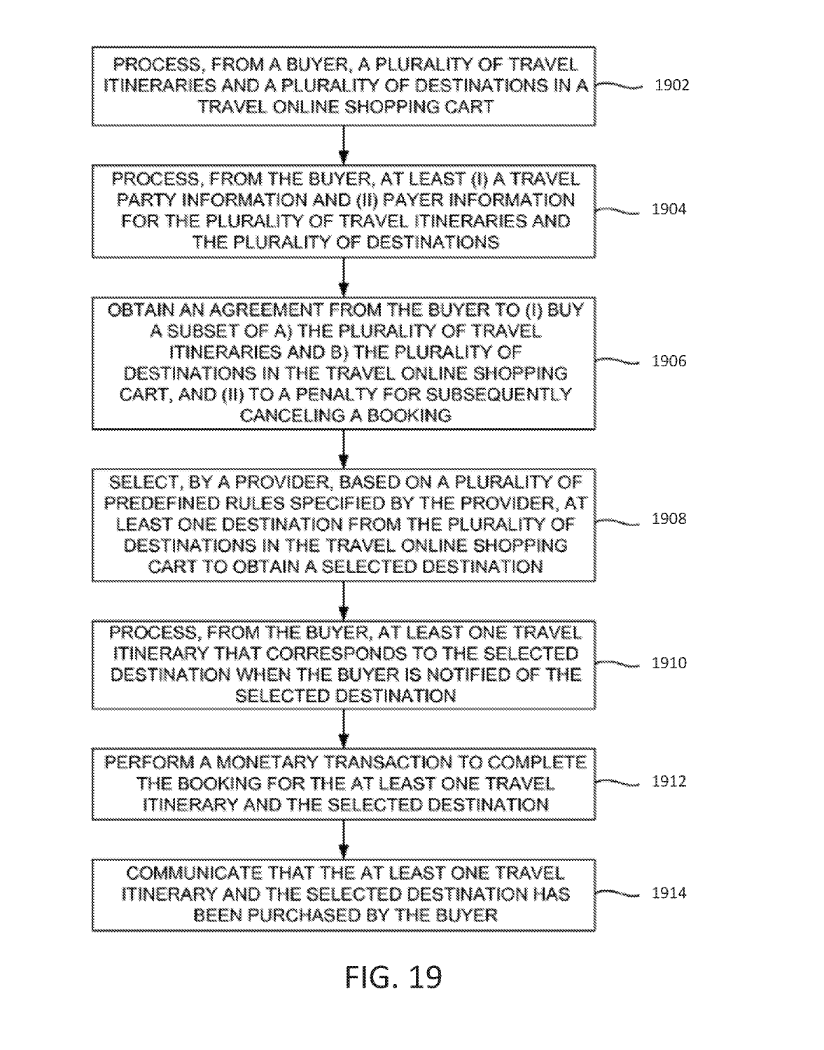

FIG. 19 is a flow chart of an example of a process for completing a booking based on two or more travel itineraries added to a travel online shopping cart according to some aspects. In step 1902, two or more travel itineraries and two or more destinations in the travel online shopping cart are processed from the buyer. The two or more travel itineraries and the two or more destinations are diverse enough as a set based on a plurality of business rules. In step 1904, at least (i) travel party information and (ii) payer information for two or more travel itineraries and two or more destinations are processed from the buyer. In step 1906, an agreement can be obtained from the buyer (i) to buy a subset of a) the two or more travel itineraries and b) the two or more destinations in the travel online shopping cart, and (ii) to a penalty for subsequently canceling the booking.

In step 1908, at least one destination from the two or more destinations in the travel online shopping cart can be selected by a provider to obtain a selected destination. The provider selects the at least one destination based on one or more predefined rules specified by the provider. In step 1910, at least one travel itinerary from two or more itineraries can be processed from the buyer when the buyer is notified of the selected destination. The provider 1206 may select a subset of the two or more travel itineraries in the travel online shopping cart to sell to the buyer 1202. The provider 1206 may provide a mechanism to the buyer to select one or more travel itineraries if the selected destination was chosen from the travel online shopping cart. The buyer selects the at least one travel itinerary from the subset of the two or more travel itineraries only when the selected destination is chosen from the travel online shopping cart. The at least one travel itinerary corresponds to the selected destination. In step 1912, a monetary transaction can be performed to complete the booking for the at least one travel itinerary and the selected destination. In step 1914, the at least one travel itinerary and the selected destination that has been purchased by the buyer can be communicated.

The travel party information may include one or more travelers. Each of the one or more travelers can be booked into the at least one travel itinerary and the selected destination. A fare for the at least one travel itinerary and the selected destination may be lower than an open market fare that corresponds to the at least one travel itinerary and the selected destination. A validity of the travel online shopping cart may be determined by the buyer based on the set of business rules. The at least one travel itinerary can be an air travel itinerary that includes a package. The package may include an air travel ticket, a hotel room, a car rental, or any other travel-related products.

The travel online shopping cart may include exactly two travel itineraries. Each of the two or more travel itineraries in the travel online shopping cart may have a different destination. Each of the different destinations may serve a different regional market. A subset of the two or more travel itineraries may overlap. An amount of the overlap may be subject to a rule set by the provider. Each of the two or more travel itineraries may have the same travel date. The two or more travel itineraries may have significantly different spans of dates. Each of the two or more travel itineraries in the travel online shopping cart may have the same destination.

A subset of the two or more travel itineraries may include air travel details that are opaque. A portion of itinerary details of the subset may be hidden for a substantial period of time when displayed to the buyer. The air travel details may include (i) operating or marketing carrier details, and (ii) departure dates. Details of the at least one travel itinerary and the selected destination may be displayed to the buyer only after performing the monetary transaction. A list of travel products may be dynamically adjusted and displayed to the buyer based on a progressive population or deletion of two or more travel itineraries from the travel online shopping cart. The list of travel products may be dynamically adjusted based on at least one adjustment criterion. The at least one adjustment criterion may be a distance between destination airports.

The list of travel products may be dynamically adjusted based on a set of airlines marketing or operating flights already in the travel online shopping cart as compared to (i) marketing candidate flights or (ii) operating candidate flights. The provider may select the at least one destination based on (i) a revenue optimization algorithm, (ii) an inventory management algorithm, (iii) an increasing consumer surplus algorithm, or (iv) combinations thereof to solve a multi-objective optimization problem. The buyer may indicate an affinity for each of the two or more travel itineraries and the two or more destinations in the travel online shopping cart. The at least one itinerary and the selected destination may be selected based on the affinity indicated by the buyer. The monetary transaction for the selected destination can be (i) not exchangeable, (ii) not refundable, (iii) not transferable, or (iv) not reimbursable, in full or in part. The at least one travel itinerary can be selected by the buyer based on a voucher or a promotional code provided by the provider when the selected destination is obtained. A deposit may be obtained to perform the monetary transaction. A balance may be obtained from the buyer, upon the buyer's selection of the at least one itinerary. The balance can be calculated based on an actual itinerary chosen.

The product selection server 1210 allows one or more providers to identify and segment customers based on the strength of their preferences for a specific product (e.g., a specific itinerary or a specific destination). The product selection server 1210 selects at least one of the two products based on one or more predefined selection algorithms (or one or more predefined rules which are specified by the one or more providers). This ensures that the products (e.g., flights) with different desirability to the consumer fill up more uniformly. The product selection server 1210 further improves price discrimination and enhances profits, or yields. The product selection server 1210 further provides flexibility to the providers to offer ancillary products/services such as hotel rooms, car rentals, and any other products to customers who have purchased a travel-related product (e.g., an airline ticket).

### Analysis of Revenue-Optimal Selection Probability

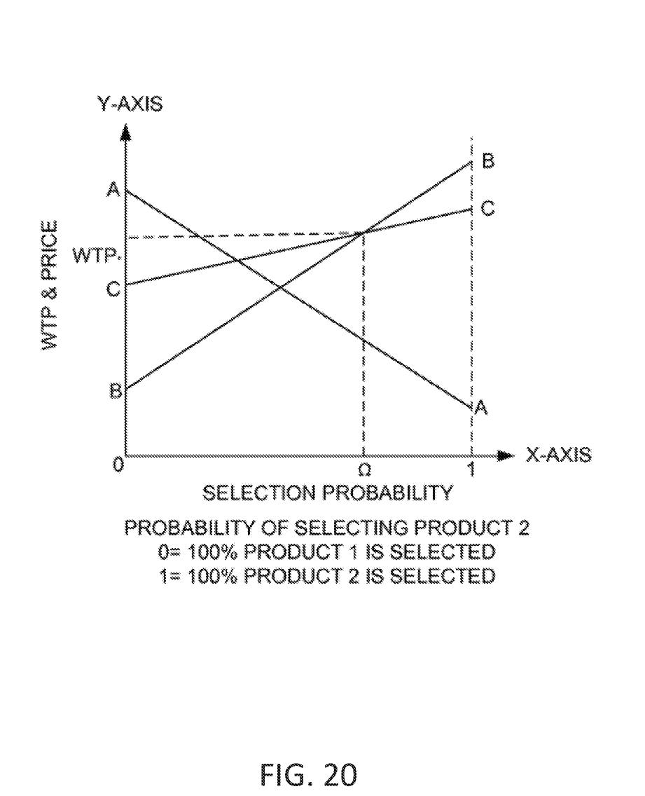

FIG. 20 is a graph of an example of a revenue-optimal selection probability of a product from the pool of substitutable product options according to some aspects. The graphical representation can be plotted with reference to willingness to pay (WTP) and price along the y-axis, and selection probability along the x-axis. For example, assume all the prospective consumers in the market are split evenly among three types denoted A, B, and C. Revenue-maximizing provider offers two products: Product 1 and Product 2. The three lines represent a willingness to pay (WTP) of each consumer for an uncertain product on the y-axis as a function of selection probability of product 2 on the x-axis (SP2). At SP2 equals zero, the WTP of A, B, and C is equal to their WTP for Product 1; at SP2 equals 1, the WTP of A, B, and C is equal to their WTP for Product 2 according to some aspects. Under these assumptions, SP2=0.750 can be seen to maximize the revenue of provider.

The revenue-maximizing provider may set the price of component products 1 and 2 to values WTP A1-2Δ and WTP B2-2Δ respectively, and set the price of the uncertain product to WTP Ω-A, where DELTA can be a small positive number. At these prices, both product 2 and the uncertain product have negative surpluses for this customer, while product 1 offers a slightly positive surplus of 2Δ. Similarly, customer B will buy Product 2, capturing the surplus of 2Δ, while customer C will buy the uncertain product, capturing the surplus of Δ. In some aspects, the airline is able to capture all revenue by making sales of products 1 and 2 directly to price-insensitive customers A and B, and selling the uncertain product to price-sensitive customer C.

In some aspects the system can be rendered entirely in software, or using both hardware and software elements. In some aspects, software can include, but is not limited to, firmware, resident software, and microcode. In additional or alternative aspects, the system can take the form of a computer program product accessible from a computer-usable or computer-readable medium providing program code for use by or in connection with a computer or any instruction execution system. For the purposes of this description, a computer-usable or computer-readable medium can be any apparatus that can store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk and an optical disk. Current examples of optical disks include compact disk-read-only memory (“CD-ROM”), compact disk-read/write (“CD-R/W”) and DVD.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (“I/O”) devices (including, but not limited to, keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

### Exemplary System Configuration

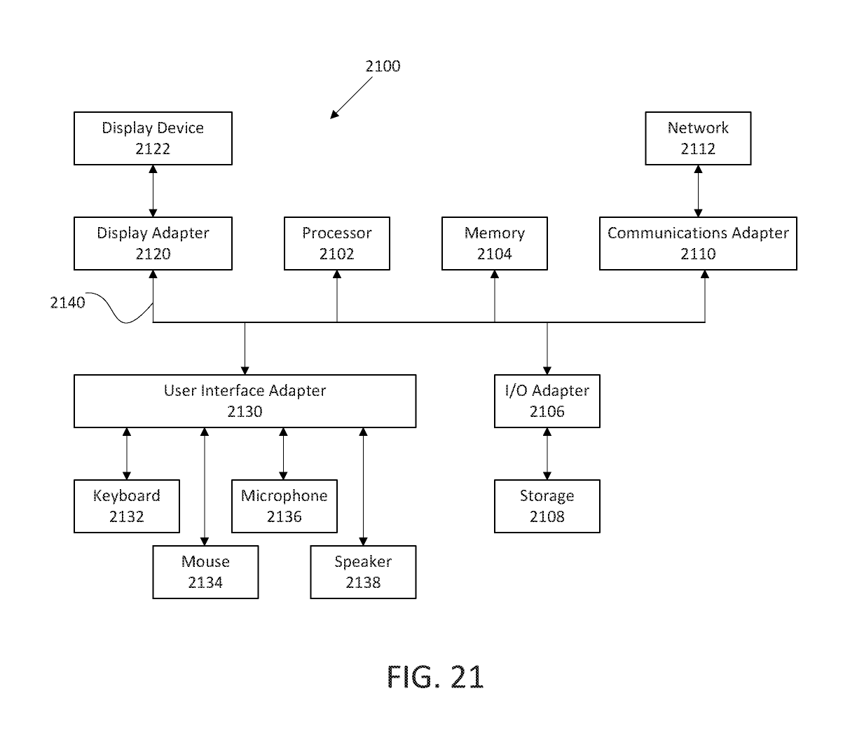

FIG. 21 is a block diagram of an example of a computer system 2100. Computer system 2100 may correspond to an apparatus that includes a processor 2102 (e.g. a central processing unit (“CPU”)), memory 2104, storage 2108, or other components found in electronic computing devices such as personal computers, laptop computers, workstations, servers, mobile phones, tablet computers, or portable media players. Processor 2102 may support parallel processing or multi-threaded operation with other processors in computer system 2100. Processor 2102 can be communicatively coupled to other components by system bus 2140. An I/O adapter 2106 can communicatively couple peripheral devices, such as disk units, tape drives, or other program storage 2108 to the bus 2140. The processor 2102 may execute instruction stored in memory 2104 or storage 2108.

The computer system 2100 may also include a user interface adapter 2130 that connects user interface devices to the bus 2140, such as a keyboard 2132, a mouse 2134, microphone 2136, or speaker 2138. Additionally, a communications adapter 2110 can connect the bus 2140 to a data processing network 2112. A display adapter 2120 can connect the bus 2140 to a display 2122, which may be embodied as an output device such as a monitor, printer, or transmitter.

In some aspects, computer system 2100 provides a system for facilitating a purchase of a travel product. The system may include an analysis apparatus that associates a user with a first market segment upon detecting a participation of the user in a first qualification event associated with the first market segment. The system may also include a presentation apparatus that provides the user with a first discount offer on a first travel product associated with the first market segment. Finally, the system may include a processing apparatus that uses the discount offer to process a purchase of the first travel product by the user upon obtaining an acceptance of the first discount offer from the user.

In additional or alternative aspects, computer system 2100 provides a system for facilitating an opaque purchase that obscures one or more details of a travel product. The system may include a presentation apparatus. Upon receiving a commitment to make the opaque purchase of the travel product by a user, the presentation apparatus may present the user with a set of purchase options associated with the opaque purchase, including a first purchase option that conforms to tone or more terms of the opaque purchase. The presentation apparatus may also obtain from the user, a selection of a purchase option from the set of purchase option. The system may also include a selection apparatus that selects the set of purchase options based on one or more attributes associates with the travel product. Finally, the system may include a processing apparatus that processes the opaque purchase with the selection.

In additional or alternative aspects, computer system 2100 provides a system for facilitating a purchase of a travel product. The system may include a presentation apparatus. Upon receiving a commitment to purchase the travel product from a first supplier by a user, the presentation apparatus may present the user with a first upgrade option of a first premium travel product from a second supplier. The system may also include a selection apparatus that selects the first upgrade option based on one or more attributes associated with the travel product. Finally, the system may include a processing apparatus that processes the purchase with the first premium travel product if the buyer accepts the first upgrade option. On the other hand, if the buyer declines the first upgrade option, the processing apparatus may process the purchase with the travel product.

Computer system 2100 may include functionality to execute various components in some aspects. In particular, computer system 2100 may include an operating system (not shown) that coordinates the use of hardware and software resources on computer system 2100, as well as one or more applications that perform specialized tasks for the user. To perform tasks for the user, applications may obtain the use of hardware resources on computer system 2100 from the operating system, as well as interact with the user through a hardware or software framework provided by the operating system.

In addition, one or more components of computer system 2100 may be remotely located and connected to the other components over a network. Portions in some aspects (e.g., presentation apparatus, analysis apparatus, processing apparatus, etc.) may also be located on different nodes of a distributed system. For example, the distributed system may be implemented using a cloud computing system that uses qualification events and discount offers to provide price differentiation of travel products to a set of remote users. In additional or alternative aspects the system may be implemented using a cloud computing system that includes multiple purchase options in opaque purchases to reduce the selection uncertainty associated with the opaque purchases for a set of remote users. In additional or alternative examples, the system may be implemented using a cloud computing system that uses upgrade options to provide price differentiation of travel products to a set of remote users.

The method described above helps the airlines or any other service providers preserve their current high-WTP buyers while, at the same time selling additional seats (or other products). The customer/buyer also benefits from a) having the certainty of selecting each of specific itineraries that are added to a shopping cart, and b) having an immediate confirmation of the purchase and a guaranteed seat upon completion of the purchase. The above method can also be implemented for selling and buying other products that can be selected based on uncertainty, and is not limited to airline travel products (e.g., a travel industry or a hospitality industry).

The foregoing description of the specific embodiments will so fully reveal the general nature of the embodiments herein that others can, by applying current knowledge, readily modify or adapt for various applications such specific embodiments without departing from the generic concept and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A system comprising:
an inventory database communicatively coupled to a network to store information about a plurality of travel products, each travel product characterized by a plurality of attributes;
a rules database communicatively coupled to the network to store rules to determine multiple purchase terms for each of the travel products, wherein different purchase terms are associated with different market segments for each travel product;
an analysis device communicatively coupled to the network for associating a user with a selected one of the market segments in response to detecting participation of the user in a qualification event associated with the selected market segment, wherein participation of the user includes receiving payment information from the user to purchase a selected travel product offered during the qualification event;
a presentation device communicatively coupled to the network for providing the user with at least one alternative travel product based on the selected market segment, wherein each of the at least one alternative travel products has at least one attribute in common with the selected travel product, and each of the alternative travel products is associated with alternative purchase terms which hide at least one attribute of the corresponding alternative product from the user; and
a processing device communicatively coupled to the network for processing a purchase of the selected travel product or one of the alternative travel products.

2. The system of claim 1, wherein one or more rules from the rules database identify the at least one alternative travel product and define the corresponding alternative purchase terms to include a price that is lower than a price associated with a different market segment.

3. The system of claim 1, wherein the selected travel product is offered by a first provider and the at least one alternative travel product is offered by a second provider and has a higher valued attribute than the selected travel product.

4. The system of claim 1, wherein a subset of the rules within the rules database are received from a travel provider associated with one or more of the travel products.

5. The system of claim 1, wherein the qualification event includes identifying at least two travel products where each travel product is associated with a different destination.

6. A method comprising:
receiving product criteria from a user;
presenting a qualification event to the user, wherein the qualification event offers the user an option to purchase a product that meets at least one of the criteria received from the user, wherein the option includes purchase terms for the product and the purchase terms hide at least one attribute of the product from the user;
when the user participates in the qualification event and provides payment information to purchase the product, then associating the user with a market segment selected from a plurality of market segments;
using the associated market segment and the criteria received from the user to identify an alternative product and alternative purchase terms;
presenting the alternative product and alternative purchase terms to the user; and
when the user selects the alternative product, completing a purchase of the alternative product on the alternative purchase terms, otherwise completing the purchase of the product on the purchase terms.

7. The method of claim 6, further comprising: when the user declines to participate in the qualification event or fails to provide payment information to purchase the product, then associating the user with a different market segment selected from the plurality of market segments.

8. The method of claim 6, wherein the at least one attribute of the product hidden from the user includes one of address, time, and travel provider.

9. The method of claim 6, wherein using the associated market segment and the criteria received from the user to identify an alternative product and alternative purchase terms comprises using a rules database to identify the alternative product and the alternative purchase terms.

10. The method of claim 6, wherein presenting the alternative product and alternative purchase terms to the user comprises hiding at least one attribute of the alternative product from the user.

11. The method of claim 6, further comprising receiving preference information from the user, wherein the preference information is used to identify the alternative product and the alternative purchase terms.

12. The system of claim 1, wherein the inventory database includes one or more travel products identified using a different booking systems, a travel product provider, or an extranets.

13. The system of claim 1, wherein one or more rules within the rules database associated with the at least one alternative travel product is dynamic and reflects an inventory level of the at least one alternative travel product.

14. A system, comprising:
an inventory database communicatively coupled to a network to store information about a plurality of travel products, each travel product characterized by a plurality of attributes;
a rules database communicatively coupled to the network to store rules to determine multiple purchase terms for each of the travel products, wherein different purchase terms are associated with different market segments for each travel product and the different purchase terms for the different market segments are based on an inventory level for the corresponding travel product;
an analysis device communicatively coupled to the network for associating a user with a selected one of the market segments in response to detecting participation of the user in a series of qualification events associated with the selected market segment, wherein participation of the user in the series of qualification events includes receiving payment information from the user to purchase a selected travel product offered during one of the qualification events, and at least one of the qualification events hides at least one product attribute from the user;
a presentation device communicatively coupled to the network for providing the user with at least one alternative travel product based on the selected market segment, wherein each of the at least one alternative travel products has at least one attribute in common with the selected travel product, and each of the alternative travel products is associated with alternative purchase terms; and
a processing device communicatively coupled to the network for processing a purchase of the selected travel product or one of the alternative travel products.

15. The system of claim 14, wherein one or more rules from the rules database identify the at least one alternative travel product and define the associated alternative purchase terms to include a price that is lower than a price associated with a different market segment.

16. The system of claim 14, wherein one or more rules from the rules database are received from a provider of one of the travel products.

17. The system of claim 14, wherein the alternative purchase terms hide at least one attribute of the associated alternative product from the user.

18. The system of claim 14, wherein the at least one alternative travel product has a higher valued attribute than the selected travel product and the purchase terms for the at least one alternative travel product is based on the purchase terms for the selected travel product.

19. The system of claim 14, wherein the series of qualification events includes identifying at least two travel products where each travel product is associated with a different destination.

20. The system of claim 14, wherein the presentation device provides all attribute information for the selected travel product after the purchase of the selected travel product is processed or provides all attribute information for the one of the alternative travel products after the purchase of the one of the alternative travel products is processed.
